(19) United States
(12) Patent Application Publication
(10) Pub. No.: US 2009/0265193 A1
(43) Pub. Date: Oct. 22, 2009

(54) METHODS AND SYSTEMS FOR AUTOMATED PROPERTY INSURANCE INSPECTION

(76) Inventors: Dean COLLINS, Manchester, CT (US); Erin Mack NAIR, Windsor, CT (US); Jared KRECHKO, Manchester, CT (US); Adam KAPROVE, South Windsor, CT (US); Henry EDINGER, Tolland, CT (US)

Correspondence Address: WILMERHALE/NEW YORK, 399 PARK AVENUE, NEW YORK, NY, 10022, US

(21) Appl. No.: 12/426,039

(22) Filed: Apr. 17, 2009

Related U.S. Application Data
(60) Provisional application No. 61/045,929, filed on Apr. 17, 2008.

(51) Int. Cl. G06Q 40/00; G06Q 10/00; B25J 19/02

(52) U.S. Cl. 705/4; 705/7; 901/46

(57) ABSTRACT

Methods and systems for automated property insurance inspection include a remote inspection device having video inspection equipment capable of providing video images of property for use by an insurance company. The images may be used for expediting claim processing, inspecting damage in hazardous or hard to reach places, loss avoidance/risk control, fraud detection, detecting changes in risk profile, underwriting, rating, and quoting on new accounts and renewals, and prospecting new customers. The inspections may be performed on the exterior or interior of the property, and may be performed periodically, on-demand or continuously.

### CROSS-REFERENCE TO RELATED APPLICATIONS

This application claims the benefit under 35 U.S.C. 119(e) of U.S. Provisional Patent Application No. 61/045,929 filed on Apr. 17, 2008 entitled “Methods and Systems for Automated Property Insurance Inspection”, which is hereby incorporated by reference herein in its entirety.

### BACKGROUND OF THE INVENTION

1. Field of the Invention

The invention relates generally to automated property inspection. More specifically, the invention relates to use of a robot to remotely inspect a property.

2. Description of the Related Art

Property insurance is a common form of insurance used to insure property. In order to be as effective as possible throughout their entire business lifecycle, insurers are constantly looking for ways to improve processes in every aspect of the insurance lifecycle. This includes processes that support market analysis, identifying new customers, underwriting/risk management, sales and policy processing (including policy quote, rate, issuance, and renewal), claim processing and any other insurance process. Improvements in any of these areas can save insurance companies time and money, which can also benefit the insured through lower premiums and/or better service.

One type of coverage offered in property insurance is to insure the property against damage. When an event occurs that requires a property damage claim to be filed, the damage must be assessed to make a determination of how much to compensate the policy holder so the damage can be repaired.

Current processes for insurance claim handling requires a claim adjuster to travel to the property to physically assess the damage to the property before a claim can be paid to the policyholder or insured or claimant. This process for handling claims can be slow as it requires that a claim adjuster (e.g., local, non-local, or third party adjuster) to travel to the property location to perform the physical inspection, which can be time consuming and tedious. Once the inspection is complete, the adjuster submits a cost estimate and damage report to the insurance company, and the insurance company then submits a payment to the insured.

As described above, the process for assessing damage claims involves estimation of expected repair or replacement costs. The inspection relies greatly upon the claim adjuster's senses, skill, and experience. Therefore, a less experienced or skilled claim adjuster may take much longer to generate an accurate assessment. The inspection process can also be dangerous. When inspecting the roof of a property, the claim adjuster often needs to climb onto the roof, and walk or crawl along it to properly perform a visual inspection. Properties can also have damaged roofs susceptible to collapse, can have other property damage in general making a property unsafe, and/or electrical problems or other hazards that make inspections dangerous. Further, it may be difficult to inspect all the parts of a property, the roof may be quite steep in certain parts or other hazards (e.g. electrical) may be present near the inspection areas. Hiring an outside contractor to consult and assist with the inspection increases costs and causes delays in the process.

All the problems described above are also present when handling claims during a catastrophe, but to an even greater degree. After a catastrophic event, such as a hurricane, tornado, flood, or other natural or man made disaster, the speed and efficiency of claim services provided by the insurance company are very important to allow the insured to begin the recovery process. Accordingly, there may be insufficient time and/or resources to properly inspect properties, or inspect them as promptly as the insurance company or the insured would like. Further, costs can be increased by the need for non-local claim adjusters to travel to the location of the damaged property, and/or the need to hire third party claim adjusters.

In view of the foregoing, what is needed is a safer, faster way to generate damage estimates which provide estimates that are at least as accurate as the current methods, especially those for roofs or other areas of an insured property that may be difficult or dangerous to inspect. Further, there is a need to quickly inspect a large number of properties, such as during or after a disaster.

Another problem in insurance operations is the inability to identify situations, in advance, that may result in losses for the policyholder as well as the insurance company. Currently, property is inspected (both inside and outside) typically (for commercial accounts) only at renewal (1 or more years apart) or when creating a new account or after a claim has been filed. For some properties, such as basic office buildings where the business activities are deemed low risk, an inspection is not performed after the initial inspection when the account is created. This infrequent inspection rate is due in part to the cost and/or resources required to perform inspections and the desire not to inconvenience the customer. Accordingly, the time between inspections can be significant, allowing many potential hazards or risks to develop or accumulate over time without the knowledge of the insurance company or possibly even the policyholder. Also, the policyholder may not realize or appreciate the danger of such risks.

Another problem in insurance operations is accurately pricing or quoting a policy. The more information that is known about a property at the time of creating a price quote for insurance coverage, the more accurate the quote will be, because it more accurately reflects the chances of loss on the account. Accordingly, it is desirable to maximize the amount and accuracy of information about a property, business or item, before providing a quote. However, this can be very resource intensive, as it requires the physical inspection of the property, business or item.

Further, yet another problem in insurance operations is identifying potential customers to target or solicit for future business. This is currently done through general advertisements in print, television, radio, mail and the internet However, the current approaches often have unpredictable results in terms of selecting low risk clients. Accordingly, it is desirable to fine a reliable way to identify potential low risk customers for future business.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like:

FIG. 1 shows the current process for handling an insurance claim.

FIG. 2A shows a remote robotic inspection device on a roof.

FIG. 2B shows various imaging inspection systems.

FIG. 3A shows a robotic inspection device.

FIG. 3B shows another embodiment of the robotic inspection device.

FIG. 3C shows another embodiment of the robotic inspection device.

FIG. 3D shows a flying robotic inspection device.

FIG. 4 shows one type of house roof that can be inspected using the present invention.

FIG. 5 shows a block diagram of one embodiment of the robotic inspection device.

FIG. 6A shows a block diagram of an inspection system and an electronic claim processing system.

FIG. 6B shows further details of an electronic claim processing system.

FIG. 7A shows a process for handling claims using a robotic inspection device at a property location.

FIG. 7B shows a process for handling claims remotely using a robotic inspection device.

FIG. 8 shows a process for performing maintenance inspections using a robotic inspection device.

FIG. 9 shows a process for performing automated inspections using a robotic inspection device.

FIG. 10 shows a process for handling insurance claims where at least one skilled adjuster works with at least one on-site laborer to perform an inspection.

FIG. 11 shows a process for handling insurance claims where at least one skilled adjuster works with at least one on-site laborer to perform an inspection after a catastrophic event.

FIG. 11A shows a process for performing a remote unskilled inspection of a property.

FIG. 12 shows a process for reviewing images to discover potential hazards or risk levels of a current insured.

FIG. 13 shows a process for reviewing images to discover potential insureds.

FIG. 14 shows a portable wireless video system capable of being used with embodiments of the invention.

FIG. 15 shows a block diagram of the communication paths and locations of people for the process of FIGS. 10-11A.

FIG. 16 shows a diagram of the network communications for the process of FIGS. 10-11A.

FIG. 17 shows a top view of the inside of a building inspected by the present invention.

### DETAILED DESCRIPTION OF EMBODIMENTS OF THE INVENTION

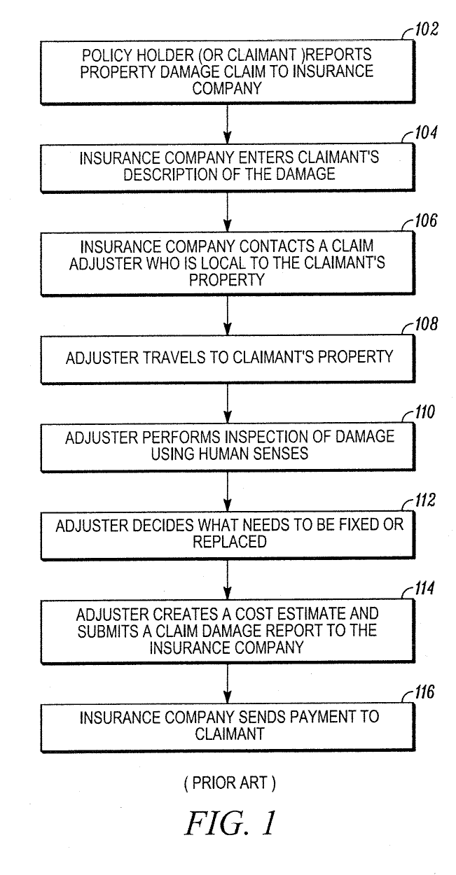

FIG. 1 describes a current process for reimbursing a policy holder (or insured or claimant) in response to a property damage claim being made. At step 102, the policy holder first reports the claim to the insurance company, for example, by phone. At step 104, the insurance company records the claim, including details of the property damage as provided by the policy holder. At step 106, the insurance company then contacts a claim adjuster that is local to the claimant's property. It is typical to send an adjuster that is local to the property to minimize costs and time. Next, at step 108, the local claim adjuster travels to the property, performs a physical inspection of the damage using his senses, such as sight, touch/feel, smell, or any other sense needed to assess the damage to the property (step 110). At step 112, the adjuster then determines what needs to be fixed or replaced based on the assessed damage. Next, at step 114, the adjuster creates a cost estimate to repair the damage to the property and submits a claim damage report to the insurance company claim processing/handling department. Then, at step 116, the insurance company sends a claim payment (if applicable) to the claimant based on the claim adjuster's report and the terms of the policy coverage.

If the damage is to the roof of a building, the claim adjuster will often climb onto the roof to inspect the damage. This allows the adjuster to visually inspect the damage close-up as well as feel the roof and shingles to detect soft spots or other damage. The claim adjuster then makes a determination using his skills and experience to determine what needs to be repaired or replaced, and how much the repair/replacement will cost.

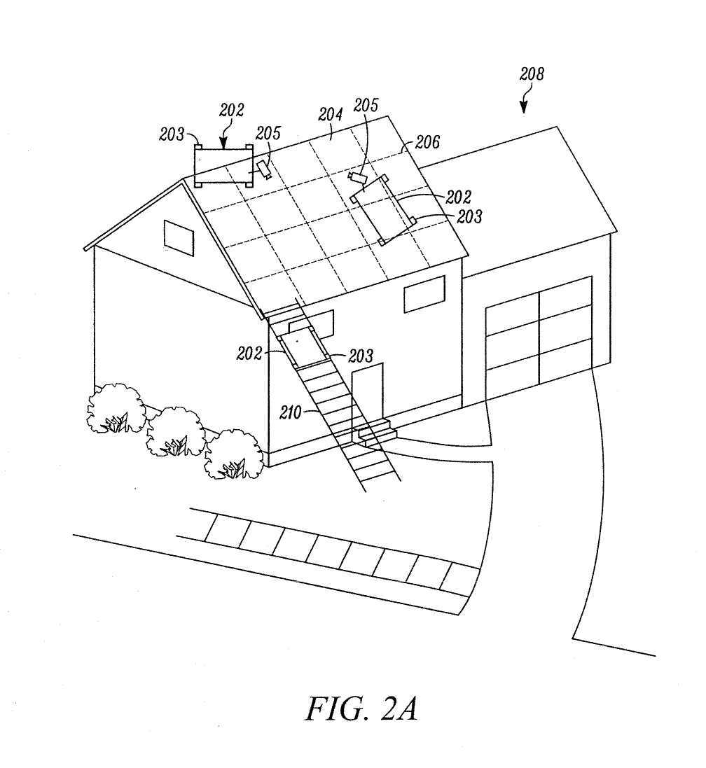

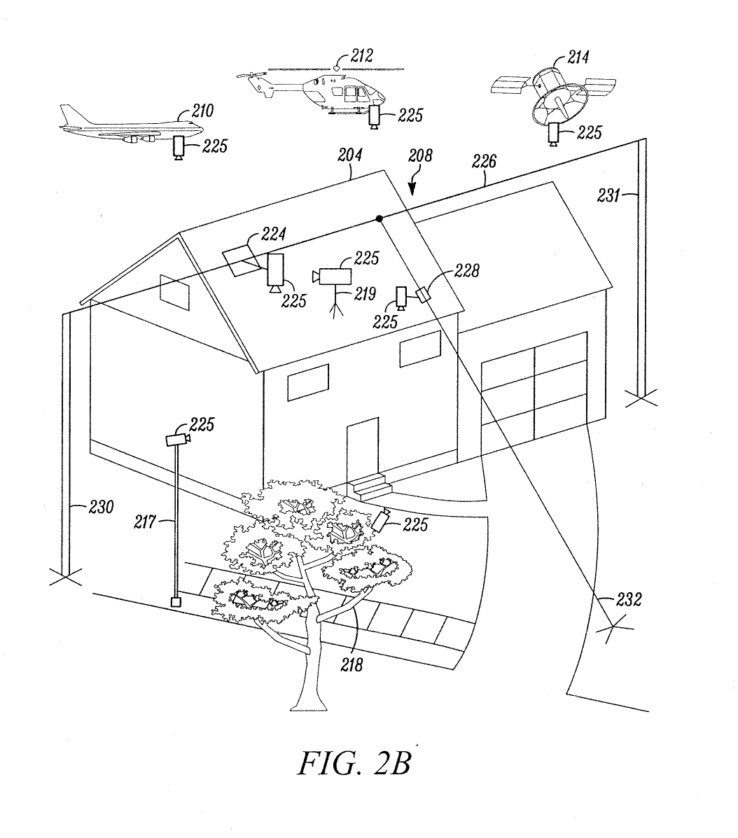

FIG. 2A shows one embodiment of the invention, which is a remote controlled robotic inspection vehicle (or device) 202 used for property inspection. The remote robotic inspection vehicle 202 has an imaging device or video inspection equipment 205 (such as a video camera or still image camera, or the like) and/or other sensors (not shown) discussed further herein as needed to perform the inspection, and has wheels 203 and can be driven along a roof 204 being inspected. The robotic inspection vehicle 202 may be any remotely controlled robotic inspection vehicle or device capable of performing any of the functions described herein. FIG. 2A shows a house 208 for which an insurance damage claim has been made due to damage to the roof 204. The robotic inspection vehicle 202 is capable of traversing the roof 204 while recording video and other sensor data. The video and other measurements can be recorded onboard the vehicle 202 for subsequent download to another computer, or transmitted wirelessly in real time during the inspection. The robotic vehicle 202 can be remotely controlled using an inspection control station or a radio controller (not shown—discussed hereinafter). The robotic vehicle 202 can be propelled by wheels, treads, belts, chains, caterpillar tracks, legs, feet, magnetic/electric fields, air flow, or any other contact or non-contact propulsion, motion, positioning technique.

The roof 204 may also have a grid 206 that may be a sensor grid to collect and/or provide sensing inspection information to the inspection vehicle 202 or other data collection device. In other embodiments, the grid 206 may be a track or other form of electrical, mechanical, or optical directional assistance for robotic inspection vehicle 202 (discussed more hereinafter).

In some embodiments, at least a portion of the roof 202 may be an intelligent or “smart” roof which can assist and/or substitute for the robotic inspection vehicle 202. A smart roof may have the ability to sense and communicate its own condition. Smart roofs have one or more sensors within or on top of the roof structure, or roofs covered with a skin, coating or material having sensors. Smart roofs can be made out of traditional building materials, such as wood, metal, steel, fiberglass, asphalt, or the like, or non-traditional materials, such as polymers, solar cells, “smart structures” or “smart skins” (such as that described in U.S. Pat. Nos. 6,986,287; 6,564,640; 5,797,623; 5,524,679, which are all incorporated herein by reference to the extent necessary to understand, make or use the present invention).

In some embodiments, such smart roofs can be used to help guide or provide data to an inspection robotic vehicle 202 or provide inspection data either to a local inspector or remotely to a monitoring station or insurance company or vendor (discussed hereinafter). Smart roofs may have active or passive sensing technology, or sensor assisting technology, to actively or passively detect and report damage. They may have embedded optical fibers, piezoelectric or piezo-acoustic sensors, polyvinalidene fluoride (PVDF) films, micro-electro-mechanical systems (MEMS) devices (including semiconductor chips having sensors fabricated thereon), or any other sensing technology that can measure stress, strain, temperature, pressure, vibration, distance, velocity, acceleration, sound, wavelength, moisture, humidity, radiation and/or chemicals, and may be distributed and/or multiplexed along the roof 204 in predetermined patterns (e.g., the grid 206), and predetermined densities or layers, for predetermined sections of the roof 204. Such a smart roof may report the amount and location of damage via wireless communications or hard wired to a portable or permanent diagnostic device (not shown). Sensor assisting technology may include optical or acoustic absorbing or reflective coatings, materials or layers on the roof that reflect or absorb certain wavelengths of light or sound and when damaged, strained, or punctured, reveal a change in the optical or acoustic reflection or absorption profile of the roof 204 when interrogated by an optical or acoustic source and associated receiver. For example, the roof 204 may be coated with a material that changes color based on the strain on the roof, which may be visible to the naked eye or only visible when interrogated with an infrared camera or inspection device. Also, smart roofs can monitor the roof 204 continuously, on demand, or on a periodic basis. Also, the robotic inspection vehicle 202 may provide the source signals to interrogate the smart roof sensors or sensor assisting technology and then report the results.

The damage to the roof 204 detected by the robotic inspection vehicle 202 or the smart roof can be reported using the wired sensor grids 206 (as hard wired data flow paths and/or transmitting or receiving antennas), RFID, WiFi, Broadband, or any other wireless methods, for transmitting data to/from the robotic vehicle 202, the smart roof, and/or other local or remote data collection device, monitoring station, or computer system for use by the insurance company or a vendor thereof (discussed hereinafter). The smart roof or inspection vehicle 202 can detect many types of damage to and/or changes in the roof, such as stresses, breaks, dimples, holes, cracks, lost shingles, or any other damage to the roof. Also, a smart roof may be able to perform a self-test periodically or on demand and transmit the data to the insurance company (or vendor thereof) to determine readiness and/or a need for service or maintenance of the roof.

In addition, a ramp 210 or other deployment device or system, may be used to deploy the inspection device 202 onto the roof 204. For some embodiments, the ramp 210 may be a ladder and the robotic inspection device 202 may have the ability to climb the ladder or the wheels 203 may run along the outer structure of the ladder. In some embodiments, a lift system (not shown) may be used to place the robotic inspection vehicle 202 on the roof 204 of the property. One type of lift system that may be used is a hand operated or powered lift. The lift may be compact and able to be easily transported to the inspection location. In other embodiments, the lift may work in connection with a ladder, such as a container holding the robot, is connected to a rope through a ladder rung using a pulley, or any other technique. The lift can have a platform on which the robotic vehicle 202 is placed and lifted onto the roof 204. One example is a lighting lift, which can be hand powered or hydraulically powered. Another type of lift system that may be used is a trailer towable lift system towed behind a claim adjuster's car. Yet another type is a lift system mounted on a vehicle, such as a cherry picker (or boom lift) or a bucket truck. Custom lift systems can also be fabricated suited for the particular robotic inspection device 202. Prefabricated “Erector Set” type pieces can also be used. A non-back-drivable driveline can also be used in the lift to prevent the lift from falling backwards. Materials that can be used are wood, aluminum (e.g. tubing, channel, angle, extrusions, steel, or poly carbonate). Any other type of lift system or ramp 210 may be used to deploy the robotic inspection vehicle 202 on the roof 204.

FIG. 2B, shows various imaging inspection embodiments of the invention. Such imaging inspection may be performed by a flying object, such as a plane 210, a helicopter, 212, a satellite 214, or any other flying object, device or vehicle. For any of these, the flying device is equipped with an imaging device or video inspection equipment 225 (such as a video camera, still picture camera, etc.) and/or other sensors discussed herein needed to perform the desired inspection. Images from the imaging device 225 can be used to assess the damage, without the need to send an inspector to the property location at all. In other embodiments, the imaging device 225 may be attached to a streetlight 217 or other stable structure. Alternatively, other objects or structures capable of providing a view of the roof, such as trees 218, telephone poles, flag poles, nearby structures/homes, or any other object or structure, can also be used. Also, the imaging device 225 may be able to pivot and change focus via remote control. In other embodiments, the imaging device 225 may be attached to a stand 219 located directly on the roof 204 or another part of the house 208. By placing the imaging device 225 at one or more strategic locations on the property or roof, the roof 204 can be completely inspected. Other sensors discussed herein can also be included and used to scan the roof at one or more locations if desired.

In other embodiments, the imaging device 225 may be movably attached to a wire 226 (or belt) connected between two poles 230 and 231 by a mechanical moving coupling 224. The wire 226 may be located above the roof 204 such that the coupling 224 does not touch the roof 204, or may act as a track for the coupling 224 to move along the roof, similar to or the same as the robotic vehicle 202 (FIG. 2A). The camera 225 can then be moved along the wire 226 to perform the inspection of the roof 204. A second wire 232 (or belt) may be connected from the ground or another pole (not shown) to connect with the first wire 226 to create a second path along which the imaging device 225 can travel, and by which the roof 204 can be more completely inspected. In addition to the imaging device 225, other sensors may be attached to the coupling (or robotic vehicle) 224. In other embodiments, the camera 225 may travel solely along the wire 232.

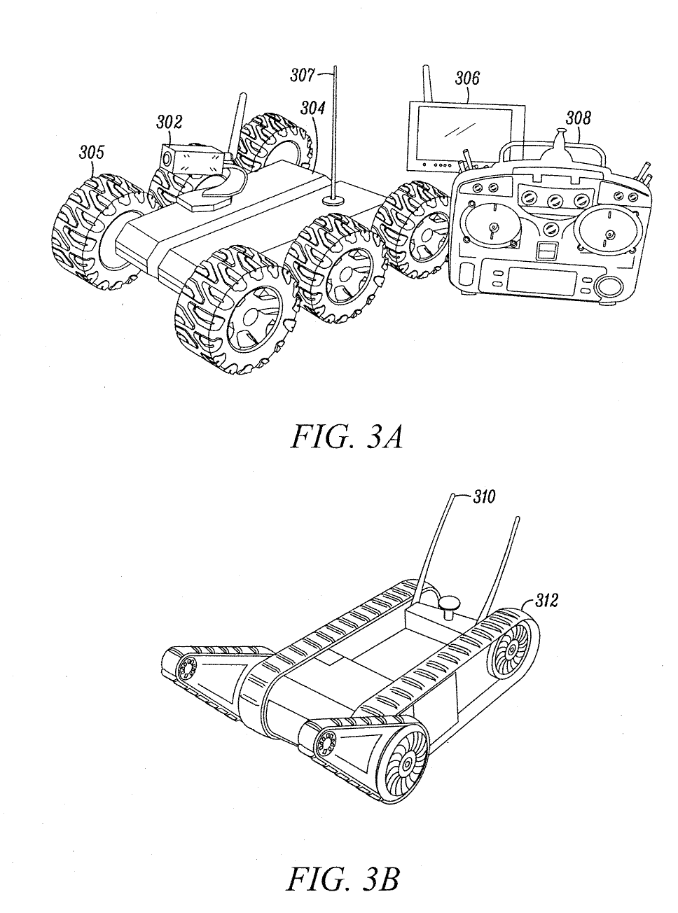

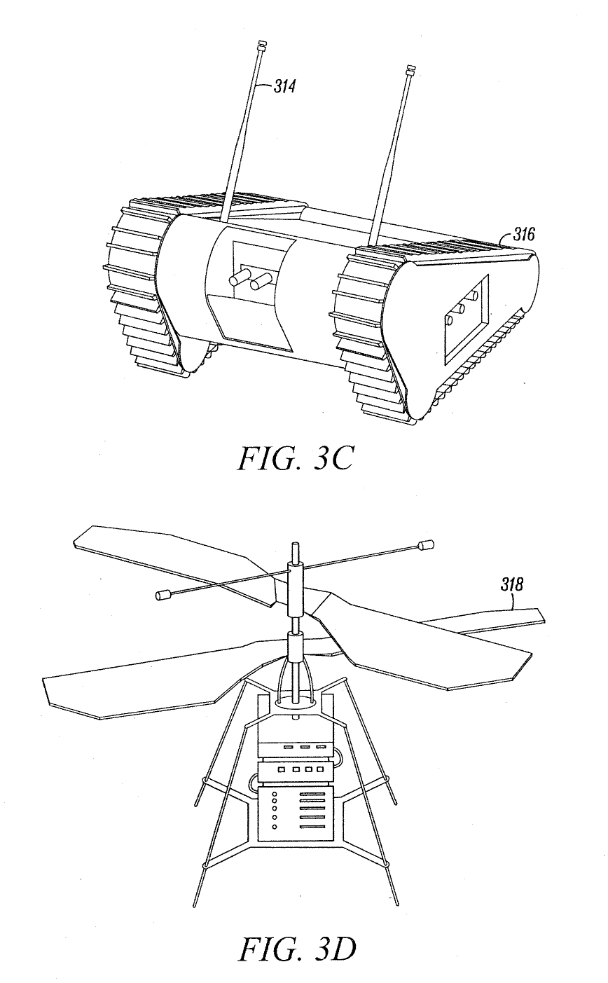

Referring to FIG. 3A, an example of the robotic inspection vehicle 202 (FIG. 2A) is shown as a vehicle 304, e.g., MMP-8 Mobile Camera Unit, made by The Machine Lab (specs available at http://www.themachinelab.com/mmp8cam.html), or may be any other inspection, surveillance, or tactical units available from The Machine Lab, such as model MMP-5, MMP-8, MMP-15, MMP-40 or MMP-40x. Some models have wheels, while other models have treads or rubber tracks. The robotic vehicle 304 has a low center of gravity and six wheels 305 for greater traction, so that climbing steep roofs is possible, even on slippery roofs (e.g. loose granules, ice, water) or in poor weather conditions. Additionally, a motor with a worm drive (not shown) may be used to prevent sliding backwards on steep slopes (e.g., roofs with a pitch of 12:12 or higher).

The robotic inspection vehicle 304 may also have a separately controllable video camera 302 to make video inspection of the roof easier. The video camera 302 can have zoom features to enable more detailed inspections, without having to move the robotic vehicle 304. An antenna 307 for wireless communication and a video monitor 306 for viewing transmitted video are also shown. A radio controller 308 for controlling the robotic vehicle 304 and video camera 302 is also shown.

The robotic inspection vehicle 202 can also be designed with easily interchangeable parts to adapt to different roofs, parts of a property, or other conditions. For example, wheels or propulsion techniques can be changed to make inspecting ducts easier.

Referring to FIG. 3B, another example of the robotic inspection vehicle 202 (FIG. 2A) is shown as a vehicle 312, e.g., Packbot Explorer robot made by iRobot, in accordance with embodiments of the invention, or may be any of the other inspection robots made by iRobot including consumer robots (Roomba, Scooba, Looj, Verro) and military/industrial robots (Packbot, Negotiator, Warrior, Seaglider, Ranger, and Transphibian). The robotic inspection vehicle 312 is similar to the vehicle 304 shown in FIG. 3A, but uses treads instead of tires to improve traction. This robotic vehicle also has an antenna 310 for wirelessly communicating information and being controlled. The two small treads in front increase mobility. The vehicle 312 is capable of climbing stairs or other obstacles, capable of surviving a two-meter drop, has a payload that can be filled with sensor and instrumentation adapted to roof inspections, and is compact enough to fit in the trunk of car. The inspection vehicle 312 can also be installed with a two-meter remote controlled extendable arm (not shown). This can be used, for example, for feeling underneath shingles.

Referring to FIG. 3C, another example of the robotic inspection vehicle 202 (FIG. 2A) is shown as a vehicle 316, e.g., the Matilda, made by Mesa Robotics, in accordance with embodiments of the invention. The robotic inspection vehicle 316 is similar to the one described with respect to FIG. 3B, but has a different tread design. It also has an antenna 314 for wirelessly communicating information. It is controlled by a briefcase operator (not shown), and can climb slopes up to 55 degrees. It also has a payload bay and is compact enough to fit in the trunk of a car.

FIG. 3D shows an example of a flying robotic inspection vehicle 318, in accordance with embodiments of the invention, e.g., prototype Epson FR-II from Seiko Epson. The robotic vehicle 318 can fly and hover like a helicopter, allowing it to more easily access all parts of a roof. As with the other inspection vehicle embodiments, information can be transmitted wirelessly and in real time for better control of the robot and the inspection process. The flying robot 318 uses an onboard battery that can sustain flight for up to 3 minutes. It has micro motors for powering the blades, as well as a gyro sensor for control. The flying robotic vehicle 318 is remote controlled using Bluetooth.

Another example of a flying robotic vehicle is the DraganFlyer X6, made by Draganfly Innovations, Inc. (not shown). It has several pairs of rotors for lift power, stability, and control. This device is particularly well-suited to the application because of its ability to self-stabilize and carry a payload of a still or video camera. Some models also include GPS and waypoint capabilities for autonomous flight. Another example is the DraganFly Tango UAV, also made by Draganfly Innovations, which is an unmanned aerial vehicle capable of autonomous flight and can capture aerial video and pictures of large areas.

Any other type of flying robotic device capable of transmitting images of the property may be used. Similarly, any other type of underwater, underground, or outer space-capable robot may be used, based on what is best suited for the desired application.

Other examples of the robotic inspection vehicle or device, may include: X-UFO made by SilverLit Electronics (better suited to indoor use); Dragonfly, made by Wowwee, a remote controlled flying device that is an “ornithopter” (i.e., it flies by flapping wings); and MicroDrone MD4-200 and MD4-1000 by Microdrone, GmbH.

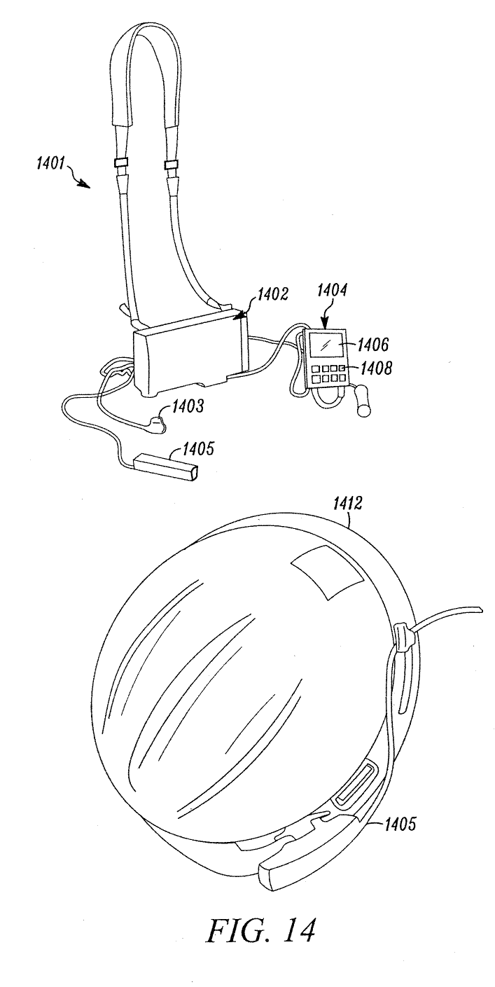

In other embodiments of the invention, the robotic inspection vehicle or device may also be portable video inspection equipment attached to the claim adjuster or to another person or laborer (or trained animal) capable of responding to commands or directions from a remote claim adjuster or other commander. FIG. 14 shows components of a portable wireless video system 1401 capable of being used with embodiments of the invention, e.g., JonesCAM made by Niche Concepts LLC. Any other type of portable video inspection equipment may be used that performs the functions described herein, such as MPEG Video Webcaster 5001 by EarthCam; HCT3 Helmet Camera by Tactical Electronics; Mobile Helmet-Camera Surveillance System by Techno-Sciences; Hero by GoPro; VholdR by Twenty20; POV.1 by VIO; ATC2K by Oregon Scientific; CAM by Xtreme Recall; AC3 by Viosport; VideoMask and Explorer by LiquidImage; Digital Mini Cam (also called Helmet Camcorder), model 500986, by Archos; and HCR-100X, HC-Pro, HC-TACT by Hoyt Technologies. Many of the above mentioned systems use cameras or imaging devices made by Sony. In other embodiments, the video inspection equipment may simply be hand held while performing the inspection.

The system 1401 may have a case 1402 which is worn by the user that may include a battery pack and a direct-to-digital video recorder and/or hard drive. The system 1401 also includes a microphone 1403, a high resolution mini-camera 1405, and an LCD screen/controller pad 1404. The camera 1405 may be mounted to a helmet, hard hat, headband, glasses, jacket, pants, shoes or other apparel or body parts or may be hand held. FIG. 14 also shows an example of the camera 1405 attached to a helmet 1412 to be worn by an inspector.

Using the video equipment 1401, a claim adjuster who is performing (or directing another person to perform) an inspection, can record video of the inspection. The video can be recorded on the portable hard drive 1402 worn with the unit, or it can be wirelessly transmitted to a computer, or transmitted in real-time to a remote person or company via any manner of data networks including, but not limited to Bluetooth, wi-fi, cellular, or WiMax. Recorded video can be downloaded to a computer using USB, firewire, or Bluetooth. The video clips and/or images can be time stamped, categorized, and/or labeled for later review.

The handheld LCD screen/controller 1404 has a screen 1406 that allows the operator to view the video as it is being recorded, and buttons 1408 to control the recording features of the system (e.g., playback).

By mounting the video camera 1405 in one of the ways described herein, the user's hands are free to perform other tasks during the inspection. Further, a remotely-located claim adjuster can get the exact same view that the operator of the system 1401 has, making it easier to direct the operator. In such an arrangement, a single claim adjuster could simultaneously inspect multiple properties located great distances from each other as well as from the adjuster's office by utilizing a network of operators who are equipped with this system or any similar system.

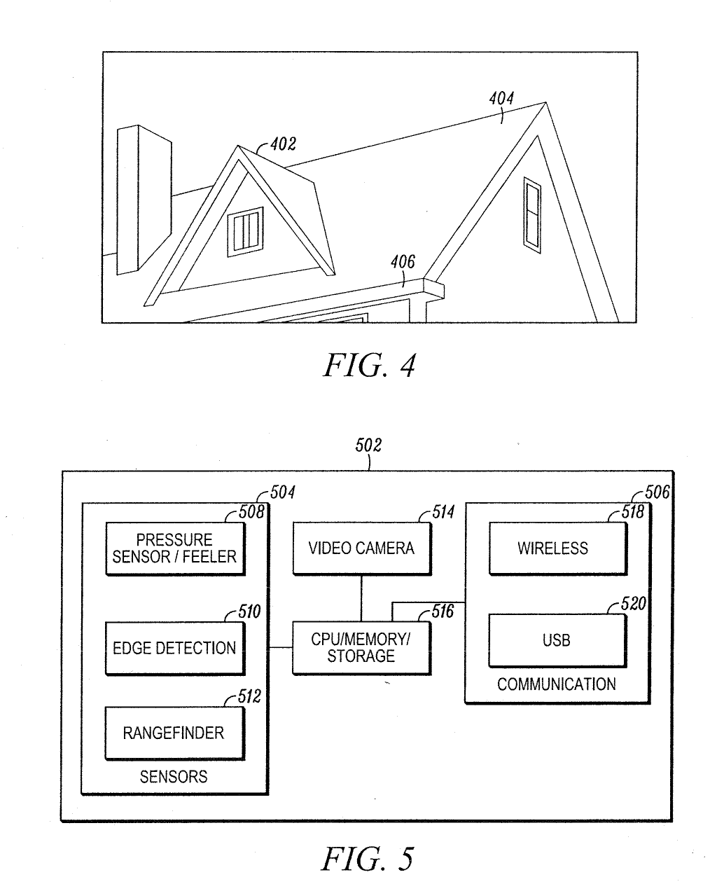

FIG. 4 shows one example of a type of roof that may need to be inspected for damage. The roof is angled and covered with shingles. The overall roof can be made of different sections (e.g. 402 and 404), each with different angles. An inspection using the robotic inspection vehicle 202 (FIG. 2A) in accordance with the present invention may be able to drive over each section of the roof, and/or be able to transition between the sections, depending on the particular application and imaging available.

The roof can have typical or specially built tracks to assist the robotic vehicle in traversing them. For example, the robotic vehicle 202 can traverse a roof following its gutters 406, edges, and joints between the peaks and valleys of the roof. In other embodiments, the robot may traverse around the roof freely. The robotic vehicle inspecting areas near the ground (e.g., a driveway), could follow pavement-grass boundaries. The robotic vehicle can also follow a specially built track, such as a permanently or temporarily installed set of guide wires, similar to that used for robotic lawn mowers or invisible fences.

FIG. 5 shows a block diagram 502 of on-board components within the robotic inspection vehicle 202 (FIG. 2A) in accordance with some embodiments of the invention. The robotic inspection vehicle 202 may have onboard computing 516, memory, and storage capabilities. This can be, for example, a microcontroller with RAM, and a hard disk or flash memory for storage. A real time operating system or other operating software can be executing on the microcontroller. The system software enables the sensors, video camera, and communication system to interface with the microcontroller. The system software also allows more sophisticated control of the robotic vehicle 202, and can process instructions received over the communication system for controlling the camera, vehicle, or sensors. The processing capabilities can be used to collect and process data from the sensors and camera before transmitting the information over the communication system to an inspection control system. In other embodiments, the robot may obtain the images and transmit them to a remote receiver having any computing, memory, and storage capability.

The electronic sensors 504 are used to collect information about the roof under inspection and to help guide the vehicle. The sensors 504 may include, for example, a pressure sensor/feeler 508, an edge detection sensor 510, and a rangefinder 512. Other sensors may be used if desired. Data from the sensors 510 can be sent to the microcontroller for further processing (e.g., for vehicle control) and/or storage before being transmitted. Data from the sensors 510 can also be analyzed using software to determine features of the property. The rangefinder 512 may be used for measuring the dimensions of a roof. The rangefinder 512 can be an ultrasonic or laser range finder or other technology. The rangefinder 512 allows the robotic vehicle 202 to measure the total size of the roof, even if the complete roof is not traversed. Alternatively, the size of the roof can be estimated by measuring the distance the robotic vehicle 202 has traveled, for example, by a sensor measuring the number of rotations of a tread or wheel of the robotic vehicle 202.

The robotic inspection vehicle 202 may also have an edge detection sensor 510. The edge detection sensor 510 can be used to prevent the robotic vehicle from being driven over the edge of the roof. It can also be used to accurately measure the dimensions of a roof when the roof can be traversed. Similarly, the robotic vehicle 202 can have a tilt sensor (not shown) to prevent operator induced flip-over.

The robotic inspection vehicle 202 may also have a pressure sensor or feeler 508. The feeler sensor 508 can be used to measure the give or softness/hardness of the roof, for example, to discover soft spots, which can indicate damaged parts of the roof. A feeler can be used to measure the texture of a shingle or the surface of the roof. This information can be used to determine if the roof has been damaged and what type of damage has occurred. For example, the feeler 508 can be used to feel the underside of a shingle for tears or other damage (e.g., a star pattern from hail damage). The feeler 508 can also feel underneath shingles to see if a membrane has been punctured.

The robotic inspection vehicle 202 may also measure the slope of a roof, e.g., using an accelerometer, electronic level, or any other technology that provides slope information. Additionally, sensors on the robot may be used to help control the robotic vehicle's acceleration and velocity.

The robotic vehicle 202 may also have a video camera 514, as discussed hereinbefore, to allow a claim adjuster to perform a visual inspection of a roof remotely. The video camera 514 can be a digital video camera that is separately controllable from the robotic vehicle 202. This allows the entire roof to be easily inspected without having to traverse the entire roof with the robotic vehicle 202. Data from the video camera 514 can be stored onboard for later retrieval, or it can be transmitted in real-time to a video display (not shown). Real-time transmission can be used to better control the robotic vehicle 202 and speed up the inspection process. The recorded digital video can be both stored on-board and transmitted in real time. The video camera 514 can have the standard features such as zoom or a light, to make the visual inspection more effective, as discussed hereinbefore.

Alternatively, or in addition to the video camera 514, the following sensors and/or measurement techniques can be used: visual light, infrared light, ultraviolet light, radioactivity, laser (LIDAR), RADAR, SONAR/acoustic, and tactile or any other sensing technology that can measure stress, strain, temperature, pressure, vibration, distance, velocity, acceleration, wavelength, moisture, humidity, radiation, and/or chemicals, may be used. These alternative types of imaging (and corresponding sensors) can provide different or additional data about a roof.

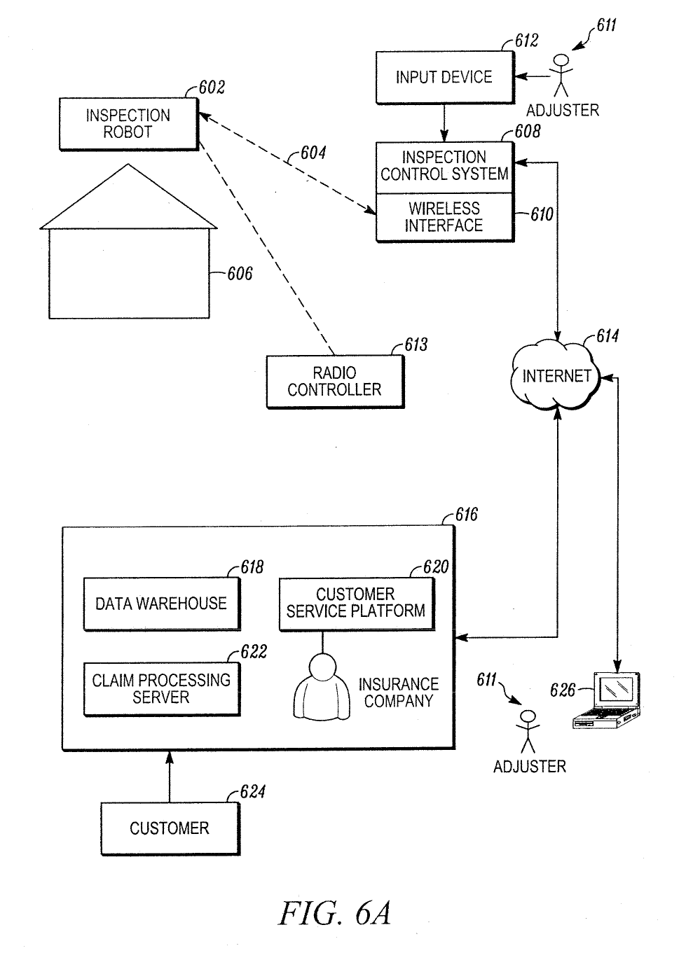

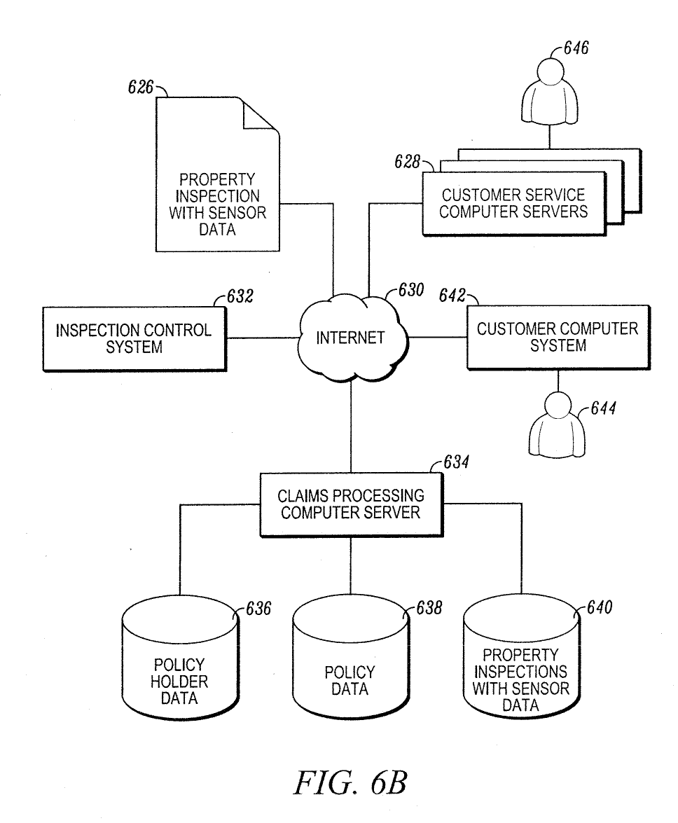

The robotic inspection vehicle 202 may also have a communication system 506 for control of the vehicle and transmission of information to an inspection control system (discussed hereinafter with FIG. 6A or directly to the internet or other network. The communication system 506 can include a wireless communication component 518, for example, cellular, Wi-Fi, Bluetooth, or direct radio communication. The communication system 506 can also include a wired communication interface 520, such as USB, Firewire, or serial communications, for downloading collected information, and uploading necessary software, instructions, or data to the robotic vehicle to perform the functions described herein. The wired interface 520 can also be used to program the robotic vehicle.

FIG. 6A shows the robotic inspection vehicle in the context of an insurance claim processing system. The robotic inspection vehicle (inspection robot) 602 is shown on the roof of a house 606 being inspected and being controlled by an inspection control system 608. The inspection control system 608 can be a computer system, such as a laptop, or handheld device with the appropriate software for operating the robotic vehicle 602 and the overall inspection process. The inspection control system 608 can communicate with the inspection robot 602 through a wireless interface 610 by wireless signals indicated by a dashed line 604 and the inspection control system 608 can also communicate with the insurance claim processing system 616 through the internet 614 or other network connection. Live video images of the inspection from the inspection robot 602 can be displayed on a video monitor (not shown) of the inspection control system 608. In some embodiments, the digital video signals may be stored on the computer server in the inspection control system 608. The inspection control system 608 may have an input device 612 (e.g., keyboard, mouse, and/or joystick) controlled by the adjuster 611 (or other person) for controlling the robotic inspection vehicle 602 and/or the associated video camera/sensors. Alternatively, software operating on the inspection control system 608 can have a control panel or interactive graphical user interface for controlling the robot 602 and/or video camera/sensors. Other features of the inspection control system 608 can include storage for storing the received data and a network connection (e.g., cellular wireless) to connect to the insurance claim processing system 616. In other embodiments of the invention, a separate radio controller 613 may be used to control the robotic vehicle 602 and/or video camera/sensors.

The inspection control system 608 can be connected through a computer network (e.g., the Internet) 614 to the insurance company's insurance claims processing system 616. By electronically connecting the inspection control system 608 to the claim processing system 616, inspection reports can be created and submitted electronically, improving the efficiency of the claim process. Also, annotations can be made to the recorded video or sensor data to form part or all of the inspection report. In this way, the inspection report can be easily generated, stored, and reviewed. Additionally, video and sensor data collected by the robotic inspection vehicle 602 can also be stored along with the report. The inspection control system 608 can also be integrated with email, messaging, and scheduling systems, allowing a claim adjuster to carry a single computer with him/her for both office tasks and inspections. The inspection control system 608 or portion thereof may be incorporated into the inspection robot 602. In that case, the robot 602 communicates with and may be controlled by commands over the internet from the adjuster's 611 computer 626 (which may also incorporate portions of the inspection control system 608 and/or the input device 612).

The reported and collected data can be stored in a data warehouse 618 where it can be accessed by a claim processing server 622 to make reimbursement payments to the policyholder. Further, the data can be accessed by customer service 620, or policy holders or customer 624 live in real time or at a later time, so that they can review the data collected during the inspection in detail. The database can be analyzed using data warehousing and analysis techniques, in order to better support the insurance company's business. For example, the data can be analyzed to determine trends and patterns in claims and damage, and this can be presented to the person reviewing this information via a computer terminal. This analysis could be assisted by a person reviewing data and video of damaged roofs. These trends and patterns can assist in making maintenance inspections, responding to disasters, or detecting fraud. It can also be used to better price insurance policies, adjust a policy holder's premiums, and/or adjust the claim reserves. Customers 624 can access the insurance company's back-end system 616 to determine information about their property inspection. Also, the customer 624 may view the inspection images and/or data over the internet or other network in real time during the inspection or after the inspection is complete. The data and images from the inspection can also be used to help reconcile questions about the adjustor's cost estimate from the policyholder and/or contractor(s) performing the repair work. The data and images can also be helpful for remote or absentee owners or managers, such as for commercial or rental properties.

FIG. 6B shows further details of the electronic insurance company claim processing system 616 of FIG. 6A, which may be referred to as a “back-end” claim system, and how it interacts with the inspection control system 608 of FIG. 6A shown as 632 in FIG. 6B. The claims processing computer server 634 coordinates data from the property inspections 626, requests from customer service representatives (or users) 646 of the insurance company customer service server 628, and customer (or policy holders or users) 644 of a customer computer system 642 which may be a PC, Laptop, cell phone, PDA, or any other device. The claim processing computer server 634 is connected to various databases 636-640, such as, a policy holder database 636, policy data database 638, and property inspections with sensor data database 640. The various components of the claim processing system can be connected through any type of data network, such as the Internet 630.

Customer service computer servers 628 are a set of computer systems and servers used by insurance company customer service representatives 646 to service the customers (or policy holders) 644. This can include responses to requests for information, processing customer claims, and dealing with customer payment issues. These customer service computer servers 628 are connected to the claims processing computer server 634 and the attached databases 636-640, therefore, they are able to access information and control the processing of a customer's claim or payment. In addition, the customer (or policyholder) 644 can perform certain tasks themselves using their customer computer system 642. The customers 644 can access the claims processing server 634 and databases 636-640 through the internet 630 or other network. The customer 644 can perform tasks similar to the insurance company customer server representative 646, including checking on the status of their claim or payment, and reviewing their property inspection video and data 626 electronically.

Claims processing server 634 is responsible for processing property inspection data 626 and applying the appropriate logic and rules to determine how to make a payment based on the inspection. The claims processing server 634 is connected to policy holder data database 636, which stores information about the policy holder for which a claim is being processed. The claims processing server 634 is also connected to policy data database 638 which includes information about a policy holder's policy, such as, the terms of the agreement, deductibles, coverage dates, etc. The claims processing server is also connected to a database or data warehouse storing the property inspections 640, including the recorded sensor data. This database can be used during the processing of an inspection to analyze and compare similar property inspections. These similar property inspections may be grouped by policy, geography, or type of damages.

Comparisons can be made for prospecting new customers, assessing a claim, detecting a fraudulent claim, or for underwriting, pricing, or rating new or existing customers (discussed more hereinafter). Although three separate databases are shown, additional sources of information can also be used by the claims processing server, and any of the databases could be combined into one large database, or multiple smaller databases. Further, each database can be hosted on a separate computer server, or multiple databases can be hosted on a single server. These databases provide information to the claims process server when it is processing claims along with the digital information in the property inspections, including the sensor data within the inspections.

Inspection control system 632 is also connected to the claims processing server 634 through the Internet 630. The inspection control system 632 can feed information directly to the claims processing server 634, and/or generate property inspection containing the same data. Further, by linking the inspection control system 632 to the customer service server 628 and customer computer system 642, both customer (or policy holder) 644 and insurance company customer service representative 464 can monitor or participate in the property inspection in realtime or at any later time.

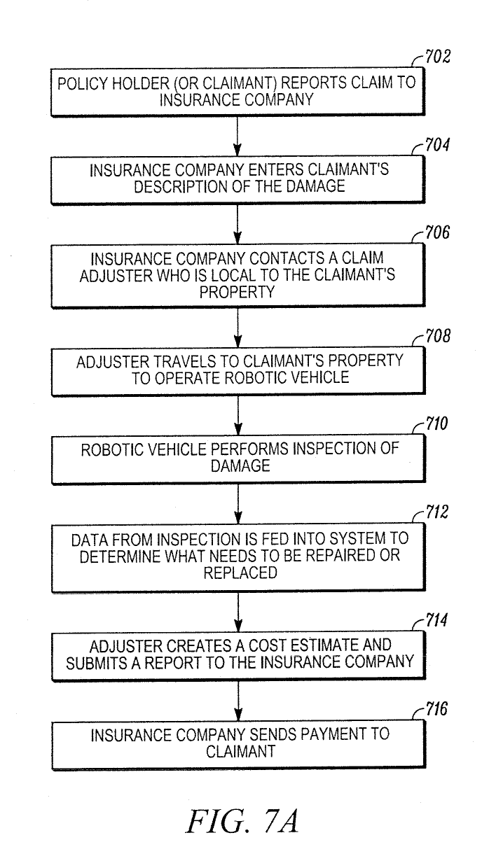

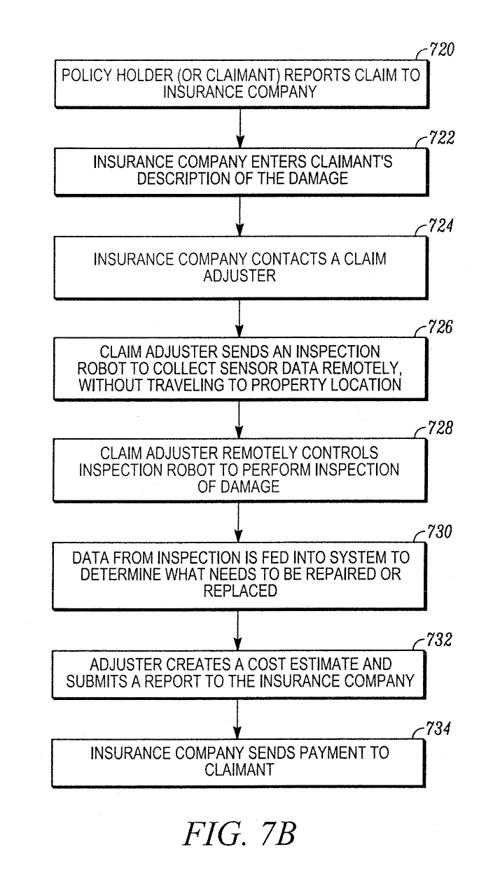

Referring to FIG. 7A and FIG. 6A, a process for processing a damage claim at a property location in accordance with embodiments of the invention begins at step 702, where the policy holder reports the damage claim to the insurance company. At step 704, the insurance company then records the damage and other details, and then contacts a claim adjuster (step 706) local to the property location. At step 708, the claim adjuster then travels to the location with the robotic inspection vehicle 602, lift system, and inspection control system 608. The robotic vehicle 602 is then deployed to the roof as described herein and the robotic vehicle 602 is controlled using the inspection control system 608. The claim adjuster then performs the inspection at step 710, and uses the live video and sensor data to assist him in controlling the robotic vehicle 602, as well as in making the inspection (step 712). The images taken may be recorded as a real time movie or as a series of snapshots taken at a predetermined image sample rate.

At step 714, after the inspection has been performed, a report and/or cost estimate is completed by the claim adjuster. This report can include any collected video or data. At step 716, the insurance company then pays the claimant for the damage.

FIG. 7B describes the process for remotely performing the inspection of a roof in accordance with embodiments of the invention. At step 720, after a claim has been submitted, the insurance company enters the claimant's description of the damage (step 722) and contacts a claim adjuster (step 724). At step 726, the claim adjuster can then send out a robotic inspection vehicle and control it remotely to perform the inspection of a damaged roof (step 728), or obtain data directly from a device or database which already has obtained and/or periodically obtains the images or data needed for the inspection. Remote control can be done, for example, over the Internet or a cellular data communication network. This allows the claim adjuster to save time by not having to travel to the property location. Embodiments described herein with FIG. 2B and FIG. 3D of the invention using a plane, helicopter, satellite, web cam, or flying robotic inspection vehicle, can be sent directly to the property location, or any other device or technique described herein for obtaining images or data regarding the property to be inspected. Step 730 shows the step of collecting information from the inspection and feeding it to processing systems (similar to FIG. 7A).

In some embodiments, a third party (e.g. shipping company or contractor) can be sent to deploy and collect a robotic vehicle or stationary system, which can be remotely controlled by the claim adjuster who is doing the inspection. Any of the techniques discussed herein for obtaining images or data about the property may be used. In some embodiments where there is no need to dispatch and control the inspection robot, steps 726 and 728 may be consolidated into a single step of retrieving images or data needed to perform the inspection, e.g., in the case of web cams, satellites, database images, etc.

After the inspection is performed, the inspection robot can be returned or sent to the next inspection location, and an inspection report (step 732) can be drafted by the claim adjuster based on the recorded video and sensor data. At step 734, the insurance company can then reimburse the claimant in the normal manner.

In some embodiments of the invention, the invention can be used to provide a preliminary inspection before an in-person inspection is done. A preliminary inspection using robotic inspection vehicles or aerial inspection can be done remotely, for example, during a disaster when there may not be enough time of claim adjusters to inspect properties in person. The preliminary inspection can then be followed up at a later time with full in-person inspection that supplements or replaces the first inspection, if needed.

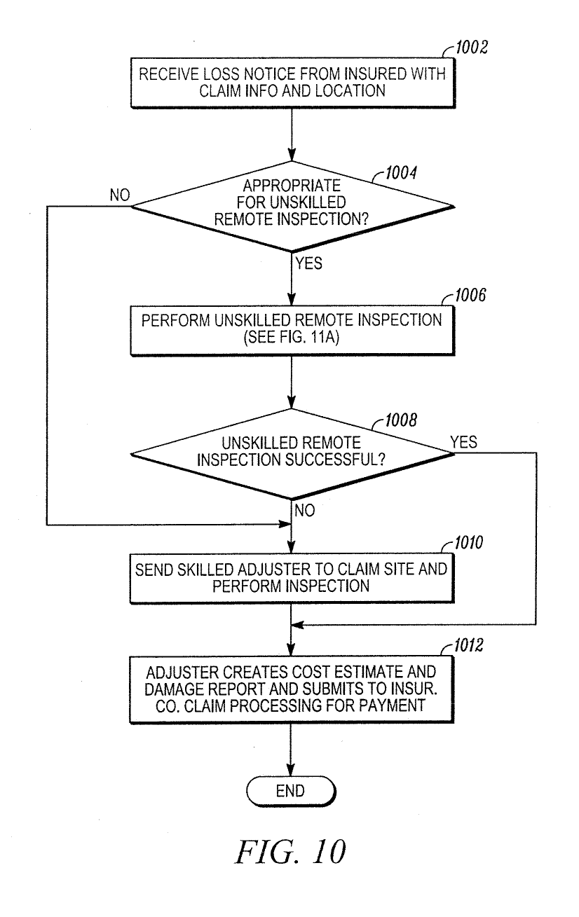

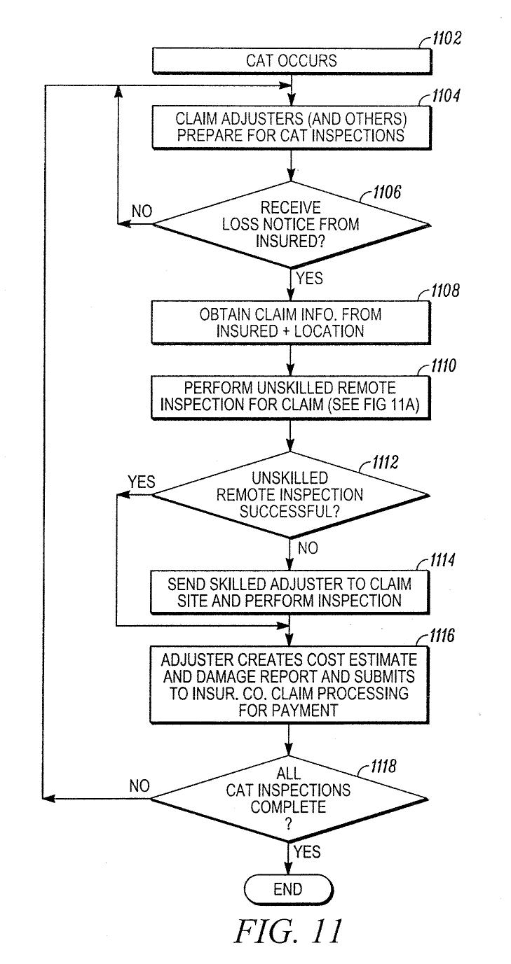

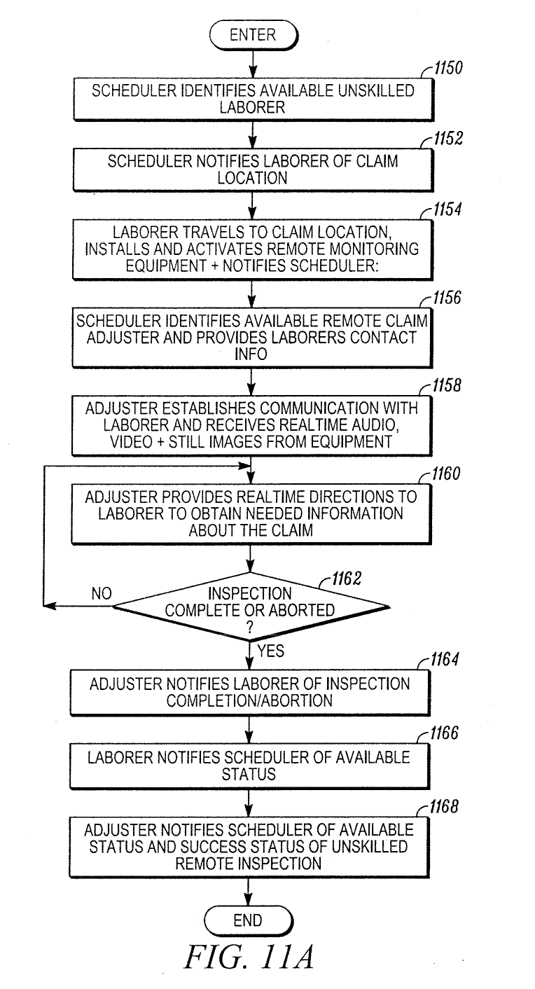

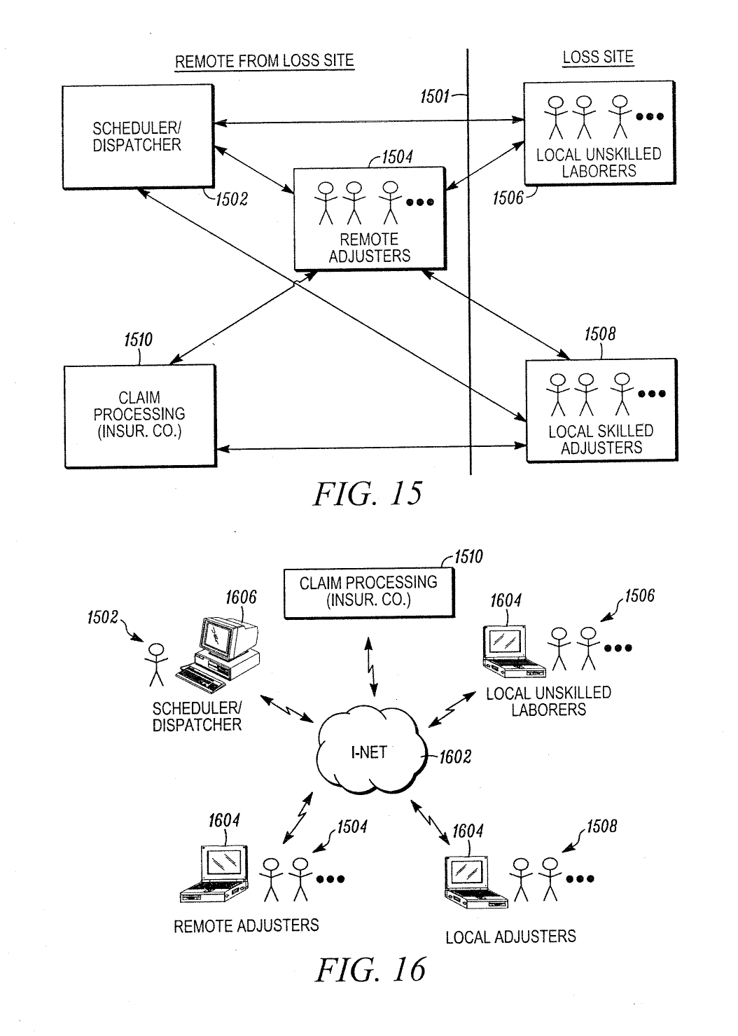

FIGS. 10, 15 and 16 describe a process for using a local (on-site) unskilled laborer 1506 with inspection robots or inspection equipment and remote skilled adjusters 1504 in communication therewith to perform a remote controlled inspection by a person (laborer) 1506 in response to a property damage claim. In FIG. 15, people shown to the right of the line 1501 are located local to the loss site and to the left of the line 1501 are located remote from the loss site. The process starts at a step 1002 when an insured reports a notice of loss (or claim) to the insurance company (or a vendor thereof), for example, through the phone, mail, or electronically over the internet, including basic claim (or loss) information and the location of the claim (loss site). Next, step 1004 determines whether the loss is appropriate to use an unskilled remote inspection. If yes, a step 1006 performs an unskilled remote inspection (described further in FIG. 11A). When the inspection in completed a step 1008 determines whether the unskilled remote inspection was successful, i.e., whether the information collected is sufficient to avoid use of a local skilled adjuster 1508. It should be understood that even when the data collected results in sending a local skilled adjuster, the unskilled remote inspection has still provided value to the overall process by providing certainty of the need for a skilled adjuster 1508 to travel to the site. If the result of step 1008 is no, or if the result from step 1004 is no, the insurance company (or scheduler or dispatcher), sends a skilled local adjuster 1508 to the claim site and the local adjuster 1508 performs the inspection at step 1010. When step 1010 is complete or if the result of step 1008 is yes (the unskilled remote inspection was successful) at step 1012, the remote claim adjuster 1504 submits a report and cost estimate to insurance company claim processing for payment to the insured.

FIGS. 11, 15 and 16 show a process for handling claims during a catastrophic (or CAT) event using local (on-site) unskilled laborers 1506 with inspection robots and remote skilled adjusters 1504 to perform the inspection in response to a property damage claim. In FIG. 15, the people shown to the right of the line 1501 are located local to the CAT loss site and to the left of the line 1501 are located remote from the CAT loss site. At step 1104, after the catastrophic event occurs (at 1102) local and remote claim adjusters (and others at the insurance company, including schedulers/dispatchers, call centers, and unskilled laborers) 1502-1508 prepare for the possibility of a large number of claims (or notices of loss) from insureds being received over a short period of time. Next, a step 1106 determines whether a loss notice has been received from an insured. If not, the claim adjusters (and others) 1502-1508 continue to prepare for inspections. When an insured reports a notice of loss to the insurance company, for example, by phone, mail, or electronically over the internet, the result of step 1106 is yes, and the insurance company obtains basic claim (or loss) information from the insured and the location of the claim at step 1108. Next, at step 1110 an unskilled remote inspection for the claim is performed as described in FIG. 11A. When the inspection is completed, step 1112 determines whether the unskilled remote inspection was successful, i.e., whether the information collected is sufficient to avoid use of a local skilled adjuster 1508. It should be understood that even when the data collected results in sending a local skilled adjuster 1508, the unskilled remote inspection has still provided value to the overall process by providing certainty of the need for a skilled adjuster 1504 to travel to the site. If the result of step 1012 is no, the insurance company (or scheduler or dispatcher), sends a skilled adjuster 1504 to the claim site and the adjuster 1504 performs the inspection at step 1114. When step 1114 is complete or if the result of step 1112 is yes (the unskilled remote inspection was successful) at step 1116, the remote claim adjuster 1504 submits a report and cost estimate to insurance company claim processing 1510 for payment to the insured. Next a step 1118 determines whether all the CAT inspections are complete. If not, the process proceeds to step 1104 to prepare and wait for the next notice of loss in step 1106.

Referring to FIG. 16, the communication between the scheduler 1502, the remote adjusters 1504, the local unskilled laborers 1506, the local adjusters 1508, and the claim processing department 1510, described with FIGS. 10 and 11 may occur over the internet 1602 or any other electronic network, using laptop computers 1604, desk top computers 1606, cell phones, personal digital assistants, or the like.

For the processes described in FIGS. 10 and 11, the robots used by the unskilled laborer 1506 may be any of the robotic inspection vehicles described herein or may be a helmet camera (or other portable inspection equipment described herein), such as described with FIG. 14, where the unskilled laborer 1506 operates the robot or inspection equipment in response to commands from a skilled adjuster 1504. In this way, the remote claim adjuster 1504 can remotely inspect the property, and have the video (or other sensor information) recorded for later annotation and archiving. The remotely recorded video can be transmitted live to the remote claim adjuster 1504 who can view it on the PC or laptop 1604 (FIG. 16), allowing the adjuster to accurately direct the unskilled labor 1506 through the inspection, for example, which direction to turn, and which features to focus on.

In some embodiments, the roof inspection robot can be remotely flown to the location. In other embodiments, no deployment may be necessary (e.g., satellite embodiments). Not needing to travel to the property location saves the claim adjuster time, which can be used to perform more inspections, which can be important, especially after a catastrophe.

As discussed herein, if the remote inspection is not successful, the local claim adjuster 1508 would perform an in-person inspection to supplement for or substitute for the remote inspection. In that case, the roof inspection robot can again be used (the same or different embodiment) to perform the inspection in person at the property if needed.

In FIGS. 10 and 11, the notices of loss, including basic claim information and location, need not always be provided by the insured. For example, when the insured contacts the insurance company, the insurance company may launch an automatic remote inspection using one or more of the remote inspection techniques described herein and proceed to the next step in the process.

FIGS. 11A, 15, and 16 show the process for performing the unskilled remote inspection referenced in FIGS. 10 and 11 hereinbefore. The process begins at step 1150 where the scheduler 1502 identifies an available unskilled laborer 1506 for the needed inspection. Next, in a step 1152, the scheduler notifies the laborer of the claim location. The laborer then travels to the claim location and installs/deploys the remote monitoring equipment, and notifies the scheduler of same, in step 1154. Next, in step 1156, the scheduler 1502 identifies an available remote claim adjuster 1504 and provides the contact information of the laborer 1506 to the adjuster 1504. Next, the adjuster 1504 establishes communication with the laborer 1506 and receives realtime transmissions of audio, video, still images, and the like, from the remote monitoring equipment, in step 1158. Next, at step 1160, the remote adjuster 1504 provides real time directions to the local laborer 1506 to obtain needed information about the claim. Then, the remote adjuster 1504 determines, at a step 1162, whether the inspection is complete or should be aborted (or terminated) based on the information collected so far. If no, the process continues to step 1160 where additional directions are provided to the laborer 1506 and more data collected by the adjuster. If the result of step 1162 is yes, the adjuster has determined that data collected is sufficient to create a cost estimate and report and the inspection is complete or that a cost estimate and report are not possible and the inspection should be aborted, and the remote adjuster 1504 notifies the laborer 1506 of this status in step 1164. Then, the laborer 1506 notifies the scheduler 1502 when the laborer 1506 is again available for another inspection in step 11166. Next, the remote adjuster 1504 notifies the scheduler 1502 whether the unskilled remote inspection was successful and, if not successful, the remote adjuster 1504 explains why not (for later communication to a local adjuster 1508) and indicates that the remote adjuster 1504 is available for the next inspection.

Because the remotely-located claim adjuster 1504 can get approximately the same view that the on-site laborer (operator of the system) has, the remote adjuster 1504 can direct the on-site laborer 1502 through the inspection via their audio and visual linkage. In such an arrangement, a single remote claim adjuster 1504 could inspect multiple properties located great distances from each other as well as from the adjuster's 1504 office by utilizing a network of on-site laborers (operators) 1506 who are equipped with this system or any similar system. In addition, a language translator could be used between an adjuster 1504 and a laborer 1506. This process fully utilizes the time of the skilled claim adjuster 1504 because travel time between loss sites would be eliminated for the claim adjusters 1504, who can now remain in a remote location. The laborers 1506 travel to the each loss site, get prepared to do an inspection, and wait for an adjuster 1504 to become available to do the inspection. The scheduler 1502 described in FIGS. 11A, 15 and 16 is optional but may be used to maximize the efficiency of the time of all parties involved including the remote adjusters 1504 and the on-site laborers 1506. It is likely that there would be more on-site laborers 1506 than claim adjusters 1504, since the on-site laborers 1506 travel to each loss location. Skilled claim adjusters 1504 can be in short supply, especially during catastrophes. Another advantage of this process is that the claim adjusters 1504 can be more fully utilized and can inspect multiple loss locations much more quickly. If a loss situation is particularly unusual, a local claim adjuster 1508 can still be dispatched to the loss location for follow up, but this approach allows the claim adjuster 1504 to apply their skill to far more locations in a single day than current methods. During a time of great demand for claim adjusters 1504, such as during a catastrophe, this approach allows the insurance company to more quickly meet the needs of its clients or claimants.

In addition, use of the remote skilled adjuster 1504 and mobile real time inspection devices may be used for training new adjusters anywhere in the world from a single location. This also allows skilled adjusters to continue to use their high level of skill, knowledge and expertise for the insurance company even when they cannot or are no longer able to travel to the claim location. It also allows a skilled adjuster to work from his/her home or any other remote location. In addition, it allows claims to be quickly estimated on an international scale. For example, a skilled claim adjuster in the United States can work with a local unskilled laborer in another country and electronically provide the estimate to the claimant in that country with minimal delay. Similarly, the time difference between countries may be used to accelerate claim payment response time. For example, skilled claim adjusters located in other countries, e.g., India, China, Europe, could perform the inspection and provide the estimate and damage report for a loss that occurs at night in the US such that the next morning, US time, the claimant may already be paid, or the claim process may be further along.

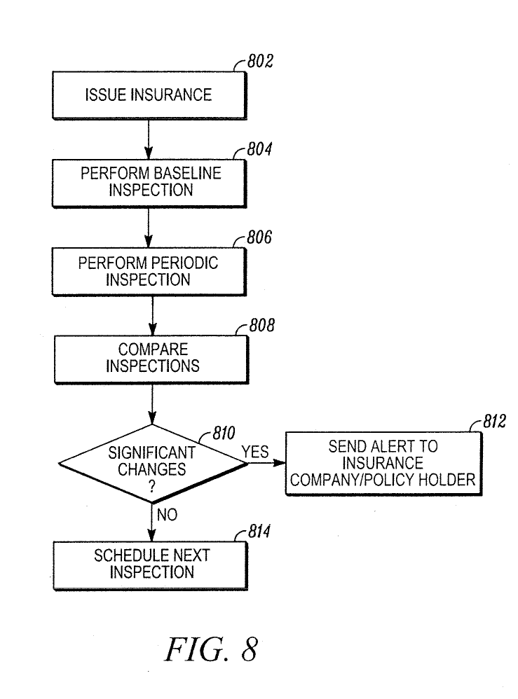

FIG. 8 describes a method for using the robotic vehicle to perform maintenance, alteration, and/or status inspections of insured property. The process starts at step 802, when an insurance policy is issued. After issuance of the policy, at step 804, a baseline inspection of the property's roof can be performed by using the robotic vehicle. The recorded video and sensor data from this inspection can be stored in the data warehouse. At periodic intervals, further inspections can be performed, for example once a year. As these periodic inspections are performed, at step 808, a comparison can be made by the claim adjuster and/or specialized software modules, between the current and previous inspections based on the recorded video and sensor data. By performing a side by side comparison, damage can be more easily detected. Further, deterioration of the roof can also be more easily detected by a side by side comparison. Other issues detectable during these inspections are large trees overhanging buildings or power lines and broken fences around potential hazards (e.g., swimming pools).

At step 810, if damage or deterioration or increased risk of any kind is detected, an alert (step 812) can be sent to the insurance company (if found by a vendor) or the policy holder so that further action should be taken. The alert can be in the form of proactive advice or fixes to prevent actual damage in the future. Alerts can be sent by any known methods, such as, email, SMS, mail, or voicemail, and may include the images (which may be annotated to show the issues) obtained of the property. At step 814, after an inspection has been performed, the next inspection can be scheduled, for example, after a predetermined time. By proactively addressing deterioration or other increased risk events, the need for more expensive reimbursements in the future can be averted as well as providing better service to the policy holder.

In some embodiments, the comparison can be done automatically by software. This software can be installed in the robotic vehicle, inspection control station, or backend claim processing system. By using the recorded video and sensor data, a comparison can be automatically done using image processing techniques. Recorded data within the data warehouse can be compared to the just collected video and sensor data. Detection can be improved by using multiple past sets of data, for example, the previous two inspections. By using electronic measurement, accuracy can be improved and quantitative values can be applied to the damage observed. This allows the differences to be automatically determined by software.

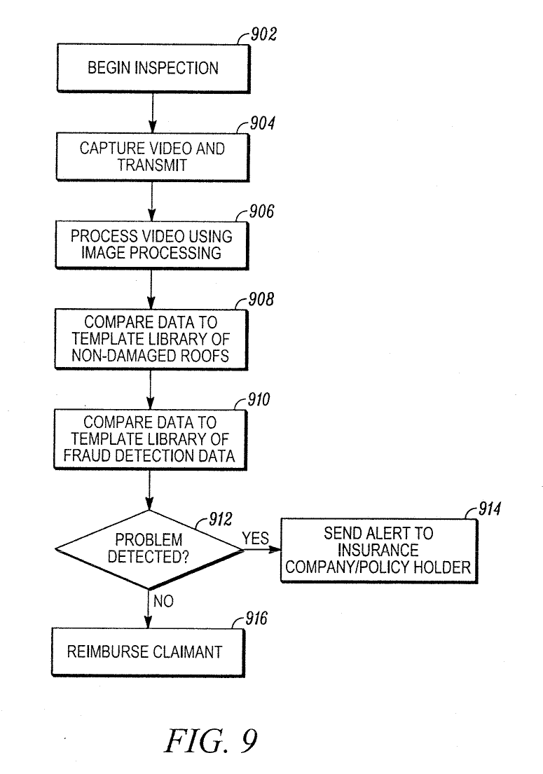

FIG. 9 describes the process for using the robotic vehicle to automatically perform an inspection of a roof. At step 902, the process begins by the claim adjuster (in response to a claim) or insurance company (on a routine basis) performing an inspection of the roof using the robotic vehicle and capturing data from electronic sensors (e.g. video) (step 904). In some embodiments, the robotic vehicle can perform the inspection automatically using a preset path, or by moving along the roof using its sensors, or by being controlled by the adjuster or another person directed by the adjuster.

As discussed hereinbefore, in some embodiments, the robotic vehicle can also be controlled or guided by a smart roof, or follow a path laid out by a smart roof (see FIG. 2A). In some embodiments, as discussed herein before, smart roofs can be used to provide data to an inspection robot or directly to an insurance company or to a computer system used thereby. In this way a smart roof can substitute for or actually become an inspection robot.

At step 906, the recorded data, for example video, can be processed using image processing software. At step 908, the recorded video and sensor data can then be compared against a template library of non-damaged roofs. Damage to a roof can then be automatically determined by detecting differences between the recorded images and the template library. The comparison can also be performed by comparing a template library of non-damaged roofs against the recorded data and looking for similarities and differences. At step 912, if a problem is detected an alert can be send to the insurance company (if found by a vendor) and/or policy holder at step 914, by phone, email or SMS/text message, so that further action can be taken, such as preventive maintenance, etc., and may include the images (which may be annotated to show the issues) obtained of the property. At step 916, the claimant can be reimbursed. A software program with artificial intelligence (learning algorithms) or designed with neural networks could also be used to detect damage. Over time, the program would learn how to distinguish damage from the images and data much in the same way human adjusters learn how to do their job.

If a problem is detected based on the comparison and a claim has not already been made, the insurance company (if detected by a vendor) or policy holder can be notified, e.g., by phone, email or text message, so that further action can be taken, such as preventive maintenance, etc., and may include the images (which may be annotated to show the issues) obtained of the property. For a roof where a claim has already been made, the claim can be automatically and electronically processed.

In addition, at step 910, the sensor data may be compared to a template library of damage claims that have been fraudulently made. Thus, by performing an automatic comparison against a template library, the claim adjuster may also be assisted with fraud detection. Also, fraud may be detected using computer based logic for various types of claims made and damages detected, e.g., for a claim of hail damage, the logic may provide patterns for typical hail damage and patterns for known fraudulent hail claims (e.g., hammering on the roof instead of hail damages). If a fraud problem is detected based on the comparison, the insurance company or policy holder may be notified so that further action can be taken—such as further investigation into the claim or other action.

Further, automatic comparisons can be used to assist a less skilled or experienced claim adjuster who can manually review the results and approve or disapprove the conclusions. This can improve the accuracy of a claim adjuster's inspections. These automatic comparisons can also help improve consistency among inspections in a group of claim adjusters.

In some embodiments of the invention, software only robots can automatically scan publicly available images to discover current hazards or risk levels of properties or to discover potential insureds. Scanning can be completely automated or human assisted. The software robot can scan images for certain features, and forward likely candidates onto a human for further detailed review. Alternatively, the software robot can scan an image and highlight or identify features that a human should be reviewing.

The number of images being reviewed can be from as few as one (depending on the application), to billions of images. Further, multiple images from the same property may be reviewed at the same time. For example, images taken from different sources, at different times, or from different angles. Review of multiple images over time can be used to determine trends, establish a pattern, or to discover something that happens infrequently. The purpose of using views from different angles might be to establish a measurement, such as the height of a fence.

The images being reviewed can be still photographs that have been converted to digital images, still photographs taken with digital photography equipment, or images derived from either analog or digital video footage. This filming furthermore can be taken by satellite, airplane, blimp, helicopter, or other flying or aerial device, automobile, train, bus, motorcycle, boat, jet ski, etc., or remote control device or robot of any of the foregoing. The images or data may also come from any kind of underwater, underground, or outer space device. The images can also have been taken by photographers on foot, or by permanently mounted cameras such as security cameras, roadside and traffic monitoring cameras, and general internet or web cameras (web cams).

One example of a vendor providing images is Pictometry. Pictometry provides oblique images taking from aerial sources. Pictometry takes high resolution oblique aerial imagery and makes them available in a database. The images are georeferenced and updated periodically (e.g., every 2 years). Alternatively, rather than using images provided by Pictometry for processing, technology such as Pictometry in combination with embodiments of the invention can be used to directly take similar images, for example by roof inspection robots, or non-contact embodiments of the invention, to provide images for analysis. Details of Pictometry technology can be found in U.S. Patent Pub. 20040105090, which is herein incorporated by reference in its entirety.

The scanning method employed by the software robot includes identifying the features of the property to search for in the images. These features can be those that are important to discovering hazards or risk levels in the properties of current policy holder, or to features that can be insured for potential insureds.

Some property features being searched for can be large (e.g., swimming pool), while other features can be small (e.g., diving board), requiring higher resolution photos. Similarly, some features can be binary (e.g., swimming pool present or not), while other features being searched for can be precise (e.g., vehicles wider than 2 meters). Other features that can be searched for include a class of objects (e.g., pool houses), which can be identified by evaluating several known criteria. Features can be considered identified when an object in an image meets all the criteria or when an object meets a predetermined portion of the criteria involved in making an identification of an object.

Example features that can be searched for and identified when scanning images, and relevant to personal lines of insurance, include for a home, the type of home, size, number of stories, number of windows, locations of window, doors, construction type, new additions, and roof type. Other features that can be searched for include the existence of boats, boat trailers, jet skis, snowmobiles, campers, trailers and automobiles. Yet other features include condition of the property, condition of roof, condition of automobiles, upkeep of the lawn, landscaping, and shrubs. Yet other features include other buildings on or near the property, such as outbuildings, garages, sheds, barns, gazebos, guest houses, pool houses and trailer homes.

Potential hazards or, conversely, safer-than-normal conditions, can be searched for and identified, such as inadequate/adequate brush clearance in brushfire areas, unfenced/fenced pond or pool, height of fence, construction of fence, adequacy of fence, diving boards, slides, junk in yard (cars, equipment, etc.)/neat yard, trampolines without enclosures/with enclosures, trees near homes/not near homes in high wind areas, size/type of trees, evidence of ATVs, dirt bike tracks, snowmobile tracks, evidence of animals (e.g. dogs, horses, goats), landscaping, gardens, retaining walls, stairs (including steepness), railings, fences, cars not sheltered, position of house/driveway—egress of driveway, steepness, curvature of street, abandoned buildings nearby, abandoned equipment. Yet other features that can be searched for and identified include infrastructure, size and type of area streets (highways, 2-lanes, 1-lane, stop lights, stop signs, fire hydrants, street lights, and, driveways, nearby schools, industrial parks, parks, businesses, commercial buildings, apartment buildings.

Some examples of features that can be searched for and identified that are relevant to commercial lines of insurance include, the type and size of a building, construction type, number of stories, parking, stairs, adequacy and condition of railings, fencing, fire escapes, condition of the roof, the building in general, parking, stairs, railings, and fencing. Other features that can be searched for and identified include, proximity to rails, waterways, highways, high power lines, towers, dangerous factories, high-liability areas (e.g. hospitals, schools, abandoned buildings), and proximity to residential areas. Yet other features that can be searched for and identified include neatness of grounds, parked vehicles, size of inventory, size of vehicle fleet, vehicles on premises, types of vehicles, trailers, and large capital equipment.

Examples of features that can be searched for and identified that are relevant to either personal or commercial lines of insurance include, buildings under construction, their location, type, and position, status and safety of construction equipment. Yet other features that can be searched for and identified for buildings under construction include the quality, type, structure, stability, position, design & safety of interim structural supports for walls, ceilings, or roofs. Yet other features that can be searched for and identified for buildings under construction include, walls, ceilings, roofs, safety fencing to keep out visitors, kids, animals, vandals, and/or thieves. Yet other features that can be searched for and identified for buildings that are currently under construction include, environmental fencing to control soil erosion, landslide, mudslide, rockslide, avalanche, water, floods, and/or wind.

An evaluation can also be made of any of the above features (commercial or personal) for risk of damage from the environment/weather, people, machines, plants or animals. Similarly, an evaluation can be made for any of the above for the risk of harm to any people, machines, plants or animals. Accordingly, in addition to insurance for property damage, the present invention may be used for personal or business general liability insurance, and, to the extent used with moving structures as described herein, then also for general liability associated with the policies for such moving structures, e.g., auto, motor, vehicle, boat, trailer, etc.

In addition, an inspection may determine or identify the cause of the damage or rule out causes of damage, e.g., caused by nature, people, machines, animals, plants and/or minerals.

After the relevant features have been determined, scanning of the images and relevant metadata can be performed using existing image processing algorithms. For those images having the relevant features, a further review can be done (e.g., review other images or review of other data sources). Alternatively, action can be taken directly from records created by the scanning procedure.

Images as well as meta-data can be scanned. Meta-data can contain information about the location of an image, the date the image was taken, the time the image was taken, the temperature when the image was taken, a holiday/special event indicator, the location of camera, or other elements. All these elements of meta-data can be used during the review process, as well as when contacting an insured or potential insured. Meta data can also help determine the most effective domain of images to be searched.

Image processing algorithms that can be used include those able to identify objects by evaluating images, those able to detect certain shapes, colors, contrasts, curvatures, angles, text, shadows, and absolute and relative sizes. Further, the algorithms include those capable of comparing the detected features to known criteria. This type of detection can also be performed by artificial intelligence algorithms, algorithms relating to 3D rendering of 2D pictures, etc.

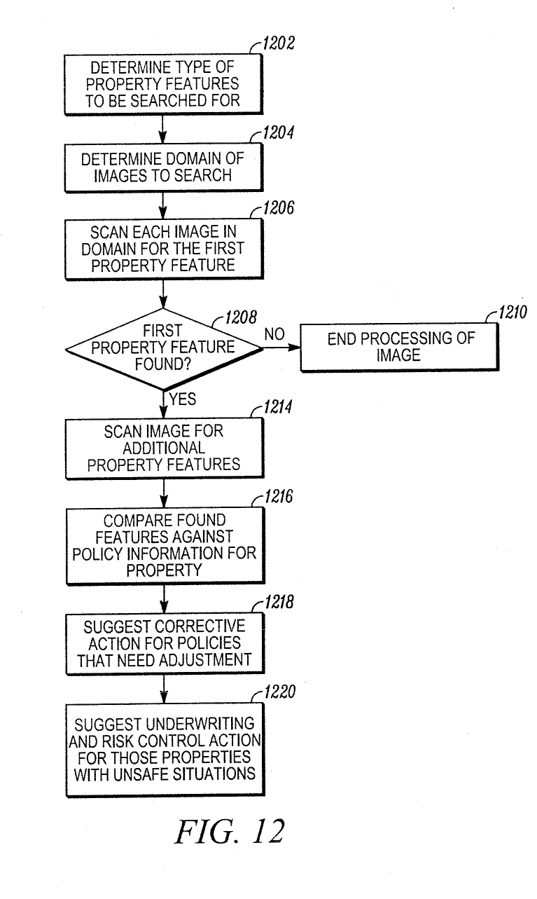

FIG. 12 shows the process for reviewing images to discover hazards or determine risk level of a current insured. At step 1202, the process begins by determining the types of features to search for and identify in the images being reviewed (scanned) (e.g. the features described above). For example, the features being searched for may be a swimming pool, including the height of fences around the pool, and the presence of diving boards and slides.

At step 1204, the process then determines the domain of images to search. This can be created from a list of all current insureds in a geographic location using geocoded address information. After the list is generated, it can be determined what set of images (based on what is available from public sources or property inspections) will be used for this purpose. There can be multiple images for each property, including from different angles or perspectives. Images can also be obtained from various vendors.

At step 1206, each image is then scanned for the first property feature. In the example above, this would be for the presence of a swimming pool. At step 1208, in those images in which a first feature, such as a swimming pool, is identified, searches for further features can be done. This can be in the same image, or other images of the property. A human can also assist at this point. An additional feature can be, for example, fences near the pool. Based on this additional feature, the height of the fences may be searched for. Other features to search for can include diving boards and slides. At step 1210, if no features are found the process ends. Otherwise at step 1214, additional features can be scanned for.

At step 1216, the features discovered from the review process are then compared with the policy information of the insured. At step 1218, corrective action can be suggested for those policies which need policy information corrected. At step 1220, in some embodiments, underwriting action (including changing rating, pricing, limits, and/or reserves or policy termination) may be suggested for those policies which have unsafe situations. In some embodiments, the insurance company may notify the insured, e.g., by phone, email or text message, so that further action can be taken, such as preventive maintenance, etc.

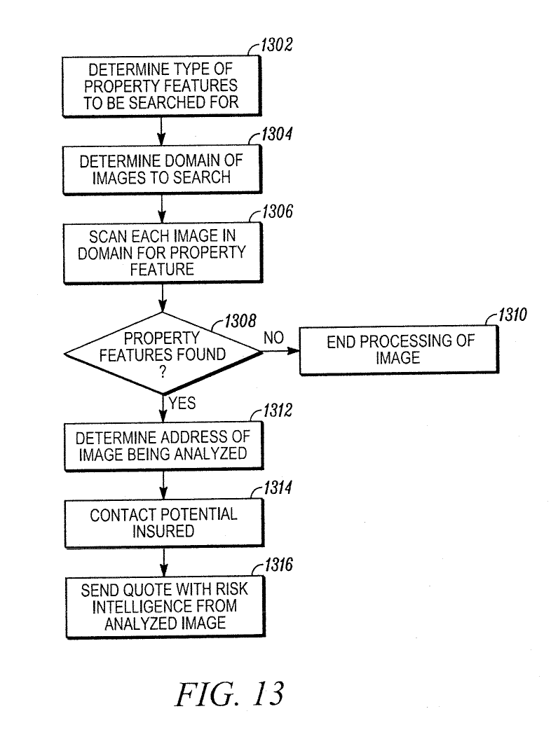

FIG. 13 shows a process for reviewing images and property information to discover potential insureds or new insurance customers. This would help the insurance company direct its sales efforts towards potential customers that demonstrate the risk characteristics that the insurance company finds favorable, or that the insurance company is proficient at writing insurance for. It is advantageous to discover those potential insureds which have desirable risk characteristics for the insurance company. For an insurance company “desirable risk characteristics” can include lower than normal risk, normal risk characteristics, or include characteristics which are riskier than the norm, but ones that an insurance company is particularly effective at understanding and pricing. For example, if the insurance company has a specialized product for companies that own bucket trucks, it would be helpful and more efficient from a marketing perspective to be able to identify companies that fit this profile. At step 1302, similar to the process described with respect to FIG. 12, the features to be searched for are first determined. For example, in a commercial property, this may be bucket trucks. At step 1304, as described with respect to FIG. 12, the domain of images to search is then determined. In the case of commercial property, this may be images of commercial property zones.

At step 1306, inspection images are then reviewed, for example, to determine the size of the bucket truck fleet. At step 1308, if no property features are found the process ends at step 1310, otherwise additional features can be searched for. At step 1312, from the images, or meta-data associate with the images, the address of the property owner is determined. At step 1314, the property owner can then be contacted for prospecting purposes to determine if the owner wants to obtain insurance. At step 1316, the property owner can be sent an insurance product designed specifically for them. The product can be based on the features identified from the image review. Still further, a quote can be sent to the property owner. The quote can be based on risk intelligence determined from the image review. The present invention may apply to property owners and/or property renters. In that case, the insurance company may contact the potential customer, e.g., by phone, email or text message, to initiate the discussion, and may include images (which may be annotated) obtained of the property.

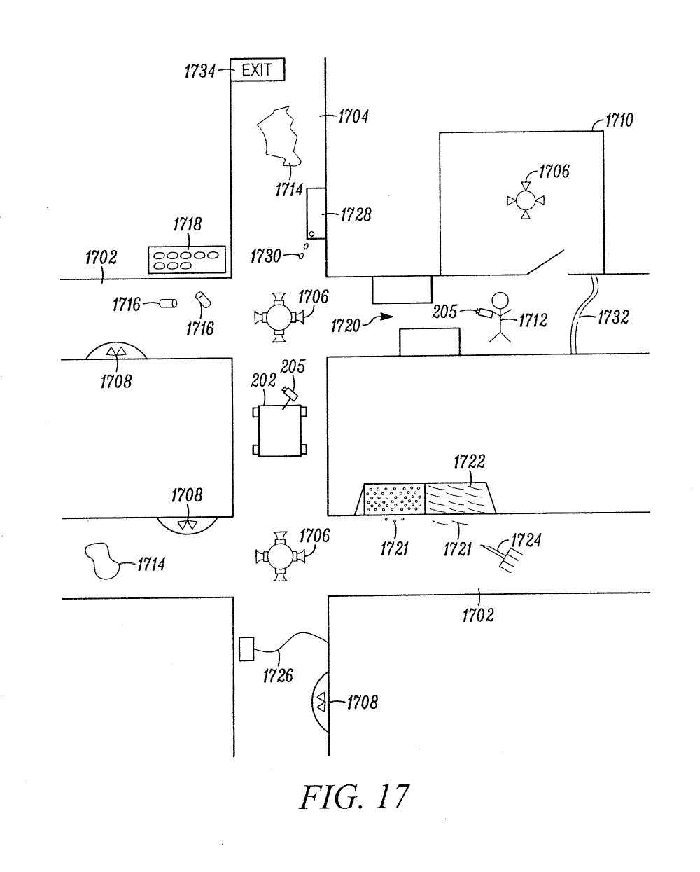

Referring to FIG. 17, the invention may also be used for performing insurance inspections inside a property. The inside of the building or premises are typically inspected for hazards, such as slip, trip and fall exposures, as well as fire, chemical, gas, water and/or electrical hazards and the safety, monitoring and prevention systems associated therewith. In particular, the invention may be used to capture images and/or measurements (from sensors) inside a building, structure, facility or premises (e.g., a house, store/shop/outlet, market, factory, warehouse, hospital, convalescent home/assisted living facility, school, library, parking garage/facility, restaurant/bar, theatre, bowling alley/facility, office building, restroom/bathroom facility, shopping mall, sports stadium/arena, fitness center, gas station/garage, airport, train/bus station, or the like) or in moving vehicles or structures (e.g., a mobile home/recreational vehicle (RV), boat, cruise ship, bus, train, airplane, spacecraft, space station, submarine, trailer, helicopter, gondola, or the like), to detect hazardous or dangerous situations such as roof leaks, electrical problems, plumbing problems, or unsafe situations of any kind, such as broken or missing railings, wet or uneven floors, burned out lighting, unmaintained sprinkler systems, debris or items on floor, or to detect any other information usable for insurance purposes. The invention could be either fully automated, partially automated, or under the control of a person while performing this task.

More specifically, FIG. 17 shows a top view of the inside of a building having hallways or walk ways 1702,1704, which people may traverse while in the building. The inspection may be performed by any of the robotic inspection vehicles, such as the vehicle 202 discussed hereinbefore with FIG. 2A, having the camera 205 and/or other sensors, as discussed hereinbefore. The inspection robot 202 may be remotely controlled by an insurance adjuster who is located inside or outside the building or at some remote location. In some embodiments, inspection cameras 1706, 1708 may be mounted in the ceiling (1706), or on the walls (1708) and may have the ability to controllably rotate about one or more axes to view down the halls 1702,1704 and/or into rooms 1710. In some embodiments, the inspection may be performed by a person having the camera 205 and/or other sensors, similar to that described hereinbefore for the skilled or unskilled person to perform. Internal inspections may also be performed as part of a damage claim inspection discussed herein. Also, any of the methods and systems discussed herein for external claim damage inspection may also be used for internal inspections.

Some examples of the types of hazards that may be identified include liquid 1714 spilled on the floor, cans or jars 1716 (which may be broken) that have fallen to the floor from a crooked shelf 1718 (or due to other reasons), a partially blocked hallway 1720, candy, fruit, or other small or slippery items 1721 that have fallen to the floor from a shelf or tray 1722, equipment or tools 1724 on the floor, a wire or cord 1726 across a walkway, a water fountain 1728 with a leak 1730, a raised crack 1732 in the floor, and an exit sign 1734 that is not illuminated.

In some embodiments, the building may be at least partially a “smart” building, which has the ability to sense (in real time, periodically or on demand), various conditions in the building and record the conditions to a local or remote computer system, or transmit the information via a network to a computer. In that case, the insurance company can connect to the network or computer system where the information is being stored and inspect the premises or perform an estimate.

If a problem, risk or hazard is detected based on the data or images collected and a claim has not already been made, the insurance company (if detected by a vendor) or policy holder can be notified, e.g., by phone, email or text message, so that further action can be taken, such as preventive maintenance, etc., and may include the images (which may be annotated to show the issues) obtained of the property. For example, if it is discovered that the same area of floor is wet more than 50% of the time, an alert notice e.g., by phone, email or text message, can be sent to the insured to check into the issue to avoid the risk of slip and fall accidents at that location. Also, the insurance company can offer a discount or credit for insureds that allow the inside of their premises to be monitored. Also, underwriting adjustments may be made on the account, similar to that discussed herein for external risks discovered as discussed in FIG. 12.

In some embodiments, after a loss event or as part of a periodic inspection update, instead of waiting for the insurance adjuster waiting for an unskilled laborer to come out to the property, the insured may choose to perform the inspection directly through use of a web cam or similar video inspection device and send the images or realtime video directly to the insurance company for processing. In that case, the claimant would interact directly with the insurance company remote claim adjuster in the same way as the unskilled laborer as described hereinbefore with FIGS. 10, 11, 11A, 15 and 16. In that case, the claimant would contact the insurance company, e.g., by phone, email, or web site, or the like, and the claimant would then be put in contact with the remote claim adjuster who would instruct the claimant on what images to capture with the video camera. The claimant may be able to do image capture with standard technology attached to a home or office personal computer or laptop. Also, the insurance company could offer a discount or credit to customers who agree to perform such a “self-inspection”. Such an approach allows the claimant to control the timing of the inspection and, as a result, expedite the claim damage estimate process, and possibly mitigate further loss, which benefits the insurance company and the claimant. This may be done for internal or external damage, loss or liability and in a CAT event or a non-CAT event.

Also, the present invention may be used for inspecting any property for insurance purposes that may be dangerous, difficult or impossible to inspect by a person, or would otherwise require disassembly, e.g., roofs, boilers, furnaces, oil rigs, wells, condemned structures, damaged structures, property having dangerous animals, air vents, water pipes, sewers, under vehicles, underwater boat hulls, spacecraft in operation, inside narrow pipes, inside pressurized vessels, behind or underneath machinery or equipment where there are only small spaces, or any other small space or dangerous, hazardous, or harsh environment. A dangerous, hazardous or harsh environment may be any environment where a human could be subject to falls, flammable, toxic or noxious chemicals, radioactivity, machinery, lack of air to breathe, extreme temperatures, or the like. Also, it should be understood that the present invention may be used for inspecting any property for insurance purposes independent of whether there is a risk or danger to the inspector.

The images used in this embodiment of the invention may be used to determine, set, and/or change: rating, pricing, premiums, policy limits, reserves, and/or risk level, of a policy. For example, if the images provide information that the risk of having a claim on a policy is higher (or lower) than originally anticipated, the insurance company may increase (or decrease) the internal financial claim reserves for that policy or associated portion thereof. In other embodiments, the insurance premiums or policy limits may be adjusted accordingly by the insurance company. Such adjustment may be made by the insurance company at any time during the current policy period after the discovery of such information by the insurance company or at the next renewal period of the policy.

The present invention may provide more precise measurement techniques for assessing property damages through the use of automation technology, which provides and may require an increased level of precision. For example, having a high resolution camera or precise pressure sensing technology may allow for more precise prediction of replacement costs and even personalized loss prevention suggestions.

The invention includes a method for inspecting at least a portion of a property for insurance purposes, comprising: obtaining at least one image of the property and determining at least one aspect of insurance relating to the property from the images. The aspect of insurance may be rating, pricing, premiums, policy limits, reserves, potential customers, risk level, loss prevention, claim appraisal/assessment, damage assessment, claim assistance, and/or any changes in any of the foregoing. In addition, the images may be digital images obtained from a computer. The present invention may be performed partially or completely by a computer.

As the invention can detect situations such as un-cleared brush in an area prone to wildfires, dead tree branches overhanging a building, damaged sidewalks in front of a business, a missing section of fencing around a pool, an added diving board, or any other potential hazard to property damage or liability, the insurance company can notify/warn the policyholder with an alert as described herein and be advised to take appropriate remediation steps to avoid loss. This information could also be used to adjust rates or potentially cancel a policy if it is no longer possible to insure the property in its present condition. In addition, as more detailed loss (or cost estimate) information is created using data from the present invention, the data could flow back to the actuarial department and help create more accurate pricing models.

Although certain embodiments of the invention have been described in terms of inspecting the roof of a property, embodiments of the invention could be adapted or applied to any part of a property or anything on a property that can be accessed by an inspection robot. Embodiments of the invention can also be applied to vehicles. Examples of things that can be inspected in accordance with embodiments of the invention are roofing, siding, masonry, foundations, basements, windows, doors, electrical fixtures, utility boxes landscaping/ornamental decorations, barns/sheds/garages, playscapes/swing sets, patio furniture, outdoor kitchens, pools, decks, stairs/railings, fences, sidewalks, driveways, parking lots, vehicles (including cars, trucks, boats, motorcycles, RV's, jet skis, farm equipment, construction equipment, cranes, etc.), lawnmowers, tractors, mail boxes, safety systems, fire detection systems, security systems, fire or lawn sprinkler systems, electrical systems (including electrical towers, substations, transformers, and power lines), plumbing, networking, environmental systems, warehouses, structural members of a building or large structure, lawns and landscaping, air quality systems, contents of a building or home, ergonomic evaluations, machinery, construction areas, constructions projects underway, bridges, tunnels, roads, ocean vessels, skyscrapers, antenna towers, and holding tanks (e.g. oil, gas, water).

Embodiments of the invention describe systems and methods for assisting a claim adjuster with inspecting a roof for damage in order to process an insurance claim. Embodiments of the invention include using various inspection robots to improve the inspection of a property. These inspection robots can include robots that are stationary or mobile, and can include contact or not contact methods. In one embodiment a robotic vehicle is used that can traverse the roof. In other embodiments, flying robots, planes, or satellite imagery can be used to inspect a roof completely remotely. Inspection can also be done by smart roofs, either alone, or with the assistance of inspection robots.

Embodiments of the invention can be integrated with backend electronic claim processing systems. Additionally, by using robots for performing the inspection, maintenance inspections can be easily and accurately performed to proactively determine if repairs need to be made. Further, the inspection robots can use image processing techniques to automatically assess damage to a roof, without the need to rely on the skill or experience of a claim adjuster or to provide suggestions to the claim adjuster. This can increase the quality, speed, and efficiency and reduce the cost of property inspections, and result in quantifiable property inspections amenable to automated processing and detailed comparison. By using robots, roof inspections can be performed more safely, more quickly, and more accurately. In addition, inspections can be performed on parts of a property that in the past might not have been inspected because of the danger of the situation.

Embodiments of the invention also may include using software only robots that can automatically scan publicly available images to discover current hazards or risk levels of properties, or to discover potential insureds. Scanning can be completely automated or human assisted (e.g. second level review or review of features identified by automated scanning). The method includes determining features of properties that are important to discovering hazards, risk levels, or potential insureds, and then scanning images and associated metadata for those features. Once images are identified having the desired features, the insureds or property owners can be contacted. These methods can advantageously be used for loss prevention, risk control, claim processing, underwriting, actuarial studies, prospecting new customers, renewing or canceling existing customers, fraud prevention, and premium audits.

Embodiments of the invention also relate generally to a method and system for determining and processing object structure condition information. More specifically, though not exclusively, the present invention also relates to use of a robot to remotely inspect a building structure.

Further, embodiments of the invention include being implemented on a computer system. The computer system includes a bus or other communication mechanism for communicating information, and a processor coupled with the bus for processing information. The computer system also includes a main memory, such as a random access memory (RAM) or other dynamic storage device, coupled to the bus for storing information and instructions to be executed by the processor. Main memory also may be used for storing temporary variables or other intermediate information during execution of instructions to be executed by the processor. The computer system further includes a read only memory (ROM) or other static storage device coupled to the bus for storing static information and instructions for the processor. A storage device, such as a magnetic disk or optical disk, is provided and coupled to bus for storing information and instructions.

The computer system may be coupled via bus to a display, such as a cathode ray tube (CRT), for displaying information to a computer user. An input device, including alphanumeric and other keys, is coupled to the bus for communicating information and command selections to the processor. Another type of user input device is cursor control, such as a mouse, a trackball, or cursor direction keys for communicating direction information and command selections to the processor and for controlling cursor movement on display. This input device typically has two degrees of freedom in two axes, a first axis (e.g., x) and a second axis (e.g., y), that allows the device to specify positions in a plane.

The invention is related to the use of the computer system for single sign on. According to one embodiment of the invention, single sign on is provided by the computer system in response to the processor executing one or more sequences of one or more instructions contained in the main memory. Such instructions may be read into the main memory from another computer-readable medium, such as a storage device. Execution of the sequences of instructions contained in the main memory causes the processor to perform the process steps described herein. One or more processors in a multi-processing arrangement may also be employed to execute the sequences of instructions contained in the main memory. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor for execution. Such a medium may take many forms, including but not limited to, non-volatile media, volatile media, and transmission media. Non-volatile media includes, for example, optical or magnetic disks, such as a storage device. Volatile media includes dynamic memory, such as main memory. Transmission media includes coaxial cables, copper wire and fiber optics, including the wires that comprise the bus. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor for execution. For example, the instructions may initially be carried on a magnetic disk of a remote computer. The remote computer can load the instructions into its dynamic memory and send the instructions over a telephone line using a modem. A modem local to the computer system can receive the data on the telephone line and use an infra-red transmitter to convert the data to an infra-red signal. An infra-red detector coupled to the bus can receive the data carried in the infra-red signal and place the data on the bus. The bus carries the data to main memory, from which the processor retrieves and executes the instructions. The instructions received by the main memory may optionally be stored on the storage device either before or after execution by the processor.

The computer system also includes a communication interface coupled to the bus. The communication interface provides a two-way data communication coupling to a network link that is connected to a local network. For example, the communication interface may be an integrated services digital network (ISDN) card or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

The network link typically provides data communication through one or more networks to other data devices. For example, the network link may provide a connection through the local network to a host computer or to data equipment operated by an Internet Service Provider (ISP). The ISP in turn provides data communication services through the world wide packet data communication network now commonly referred to as the “Internet”. The local network and the Internet both use electrical, electromagnetic or optical signals that carry digital data streams. The signals through the various networks and the signals on the network link and through the communication interface, which carry the digital data to and from the computer system, are exemplary forms of carrier waves transporting the information.

The computer system can send messages and receive data, including program code, through the network(s), the network link and the communication interface. In the Internet example, a server might transmit a requested code for an application program through the Internet, the ISP, the local network and the communication interface. In accordance with the invention, one such downloaded application provides for single sign on as described herein.

The meaning of the term “remote inspection device” as used herein includes any of the embodiments described herein of the robotic inspection vehicles, devices or systems, video inspection equipment or system, sensors and sensing technology, smart roofs, smart buildings, and the combination of video inspection equipment with a person (or animal) receiving remote commands.

Also, it should be understood that the invention is not limited in its application to the details of construction and to the arrangements of the components set forth in the description or illustrated in the drawings herein. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

For example, the specific sequence of the above described process may be altered so that certain processes are conducted in parallel or independent, with other processes, to the extent that the processes are not dependent upon each other. Thus, the specific order of steps described herein are not to be considered implying a specific sequence of steps to perform the above described process. Other alterations or modifications of the above processes are also contemplated. For example, further insubstantial approximations of any of the above equations, processes and/or algorithms are also considered within the scope of the processes described herein.

What is claimed is:

1. A method for processing a property insurance claim for an insured property comprising:
(a) receiving a claim for property damage from a policy holder;
(b) receiving, a property inspection for the insured property, performed in response to the claim received from the policy holder, wherein the property inspection includes digital information collected using a remote inspection device, and wherein the remote inspection device collects information about the damage to the insured property recorded using at least one electronic sensor;
(c) determining a cost estimate using the property inspection and the collected digital information; and
(d) transmitting to the policy holder payment information based on the processing of the property insurance claim.

2. The method of claim 1, wherein the digital information is compressed video information and wherein the electronic sensor is an image sensor.

3. The method of claim 1, wherein electronic sensor is at least one of a pressure sensor, an edge detection sensor, and a rangefinder.

4. The method of claim 1, wherein the remote inspection device is a robot, and the electronic sensor is attached to a robot, and the robot automatically collects the digital information.

5. The method of claim 1, wherein the property inspection further comprises digital information provided by at least one sensor in a smart roof.

6. The method of claim 1, further comprising transmitting receiving the property inspection using a wireless network.

7. The method of claim 1, further comprising: performing fraud detection on the received claim by determining, using a computer processor and the digital information, at least one feature of the insured property relevant to the property inspection;
electronically comparing the at least one feature to a database of similar features, wherein the similar features are features known to be fraudulently caused; and
determining if the at last one feature was fraudulently caused based on the comparison.

8. The method of claim 7, wherein the cost estimate is determined automatically by a computer processor using the property inspection and the collected digital information.

9. A system for processing a property insurance claim for an insured property comprising:
(a) a claim received for property damage from a policy holder;
(b) a computer server receiving a property inspection for the insured property, performed in response to the claim received from the policy holder, the property inspection includes digital information collected using a remote inspection device, wherein the remote inspection device collects information about the damage to the insured property recorded using at least one electronic sensor, and wherein a cost estimate is determined using the property inspection and the collected digital information; and
(c) payment information being transmitted to the policy holder based on the processing of the property insurance claim.

10. The system of claim 9, wherein the digital information is compressed video information and wherein the electronic sensor is an image sensor.

11. The system of claim 9, wherein electronic sensor is at least one of a pressure sensor, an edge detection sensor, and a rangefinder.

12. The system of claim 9, wherein the remote inspection device is a robot, and the electronic sensor is attached to a robot, and the robot automatically collects the digital information.

13. The system of claim 9, wherein the property inspection further comprises digital information provided by at least one sensor in a smart roof.

14. The system of claim 9, further comprising transmitting receiving the property inspection using a wireless network.

15. The system of claim 9, further comprising: performing fraud detection on the received claim by determining, using a computer processor and the digital information, at least one feature of the insured property relevant to the property inspection;
electronically comparing the at least one feature to a database of similar features, wherein the similar features are features known to be fraudulently caused; and
determining if the at last one feature was fraudulently caused based on the comparison.

16. The system of claim 15, wherein the cost estimate is determined automatically by a computer processor using the property inspection and the collected digital information.

17. A method for predicting property insurance claims for an insured property using a baseline property inspection comprising:
(a) receiving, a first baseline property inspection for the insured property, performed at a first time including first digital information about the condition of the property from at least one first electronic sensor, and wherein at least one feature of the property relevant to the property inspection is determined from the first digital information using a computer processor to process the first digital information received from the first electronic sensor;
(b) receiving, a second updated property inspection for the insured property, performed at a second time, including second digital information about the condition of the property, from at least one second electronic sensor, and wherein at least one feature of the property relevant to the property inspection is determined from the second digital information using the computer processor to process the second digital information received from the second electronic sensor;
(c) comparing, using the computer processor, the first baseline property inspection received at the first time with the second updated property inspection received at the second time; and
(d) alerting the policy holder of the insured property when, based on the comparison, the updated property inspection received at the second time is significantly different than the baseline property inspection received at the first time.

18. The method of claim 17, further comprising:
receiving, a property inspection for the insured property, performed at a third time, wherein the property inspection includes digital information about the condition of the property, and wherein the digital information is recorded using at least one electronic sensor; and
comparing the property inspection received at the first time with the property inspection received at the third time.
alerting the policy holder of the insured property when, based on the comparison, the property inspection received at the third time is significantly different than the property inspection received at the first time.

19. The method of claim 17, further comprising receiving a property inspection for the insured property periodically, wherein the property inspection includes digital information about the condition of the property, and wherein the digital information is recorded using at least one electronic sensor; and
electronically comparing the property inspection received at the first time with last the property inspection received.

20. The method of claim 17, further comprising scheduling a more detailed property inspection when, based on the comparison, the property inspection received at the second time is significantly different than the property inspection received at the first time.

21. The method of claim 17, wherein comparing the property inspection received at the first time with the property inspection received at the second time is automatically performed using image processing software.

22. The method of claim 17, wherein the digital information is compressed video information and wherein the electronic sensor is an image sensor.

23. The method of claim 17, wherein electronic sensor is at least one of a pressure sensor, an edge detection sensor, and a rangefinder.

24. The method of claim 17, wherein the electronic sensor is attached to a robot, and the robot automatically collects the digital information.

25. A system for predicting property insurance claims for an insured property using a baseline property inspection comprising:
(a) a computer server receiving a first baseline property inspection for the insured property, performed at a first time including first digital information about the condition of the property from at least one first electronic sensor, and wherein at least one feature of the property relevant to the property inspection is determined from the first digital information using a computer processor to process the first digital information received from the first electronic sensor;
(b) the computer server receiving a second updated property inspection for the insured property, performed at a second time, including second digital information about the condition of the property, from at least one second electronic sensor, and wherein at least one feature of the property relevant to the property inspection is determined from the second digital information using the computer processor to process the second digital information received from the second electronic sensor;
(c) the computer processor comparing the first baseline property inspection received at the first time with the second updated property inspection received at the second time; and
(d) an alert being sent to the policy holder of the insured property when, based on the comparison, the updated property inspection received at the second time is significantly different than the baseline property inspection received at the first time.

26. The system of claim 25, further comprising:
receiving, a property inspection for the insured property, performed at a third time, wherein the property inspection includes digital information about the condition of the property, and wherein the digital information is recorded using at least one electronic sensor; and
comparing the property inspection received at the first time with the property inspection received at the third time.
alerting the policy holder of the insured property when, based on the comparison, the property inspection received at the third time is significantly different than the property inspection received at the first time.

27. The system of claim 25, further comprising receiving a property inspection for the insured property periodically, wherein the property inspection includes digital information about the condition of the property, and wherein the digital information is recorded using at least one electronic sensor; and
electronically comparing the property inspection received at the first time with last the property inspection received.

28. The system of claim 25, further comprising scheduling a more detailed property inspection when, based on the comparison, the property inspection received at the second time is significantly different than the property inspection received at the first time.

29. The system of claim 25, wherein comparing the property inspection received at the first time with the property inspection received at the second time is automatically performed using image processing software.

30. The system of claim 25, wherein the digital information is compressed video information and wherein the electronic sensor is an image sensor.

31. The system of claim 25, wherein electronic sensor is at least one of a pressure sensor, an edge detection sensor, and a rangefinder.

32. The system of claim 25, wherein the electronic sensor is attached to a robot, and the robot automatically collects the digital information.

33. A method for performing an underwriting action with respect to a property insurance policy of a policy holder comprising:
(a) receiving a first property inspection for a first insured property, wherein the property inspection includes first digital information about the physical condition of the first insured property, and wherein the first digital information is recorded using at least one electronic sensor;
(b) storing the first digital information on storage device in communication with a computer server;
(c) electronically comparing, by a computer processor, a first portion of the first digital information of the first property inspection to a second portion of second digital information of a second property inspection, wherein the second property inspection is for a similar second insured property, and includes the second digital information about the physical condition of the second property, and wherein the comparison is performed automatically by the computer processor;
(d) detecting at least one feature of the first insured property that is not compliant with the terms of the property insurance policy of the policyholder based on the comparison of the first property inspection to the second property inspection;
(e) performing an underwriting action based on the detected non-compliance; and
(f) transmitting to the policy holder information regarding the underwriting action.

34. The method of claim 33, wherein the underwriting action is at least one of changing a rating, changing pricing, limits, reserves and policy termination, of the property insurance policy of the policy holder.

35. The method of claim 33, wherein the digital information comprising remotely taken photographs.

36. The method of claim 35, wherein the photographs are taken using a satellite.

37. The method of claim 33, where in the feature detected is a property hazard.

38. The method of claim 33, wherein the similar property inspection is from the same geographic area as the insured property, and this is determined using geocoded address information.

39. The method of claim 33, wherein the comparison uses a plurality of images, and at least two of the images are from different perspectives.

40. The method of claim 33, further comprising analyzing additional digital information about an insured property upon detection of a particular feature.

41. A system for performing an underwriting action with respect to a property insurance policy of a policy holder comprising:
(a) a first property inspection for a first insured property, wherein the property inspection includes first digital information about the physical condition of the first insured property, and wherein the first digital information is recorded using at least one electronic sensor;
(b) storing the first digital information on storage device in communication with a computer server;
(c) a computer processor electronically comparing a first portion of the first digital information of the first property inspection to a second portion of second digital information of a second property inspection, wherein the second property inspection is for a similar second insured property, and includes the second digital information about the physical condition of the second property, and wherein the comparison is performed automatically by the computer processor;
(d) the computer processor detecting at least one feature of the first insured property that is not compliant with the terms of the property insurance policy of the policyholder based on the comparison of the first property inspection to the second property inspection, and performing an underwriting action based on the detected non-compliance.

42. The system of claim 41, wherein the underwriting action is at least one of changing a rating, changing pricing, limits, reserves and policy termination, of the property insurance policy of the policy holder.

43. The system of claim 41, wherein the digital information comprising remotely taken photographs.

44. The system of claim 43, wherein the photographs are taken using a satellite.

45. The system of claim 41, where in the feature detected is a property hazard.

46. The system of claim 41, wherein the similar property inspection is from the same geographic area as the insured property, and this is determined using geocoded address information.

47. The system of claim 41, wherein the comparison uses a plurality of images, and at least two of the images are from different perspectives.

48. The system of claim 41, further comprising analyzing additional digital information about an insured property upon detection of a particular feature.

49. A method for identifying new customers for a property insurance product comprising:
(a) receiving, a property inspection for a property of a non-policyholder, wherein the property inspection includes digital information about the physical condition of the property, and wherein the digital information is recorded using at least one electronic sensor;
(b) electronically comparing, by a computer processor, the property inspection to at least a portion of the digital information of a similar property inspection, wherein the second property inspection is for a similar insured property, stored in a database of property inspections, and includes digital information about the condition of the property, and wherein the comparison is performed automatically by the computer processor;
(c) detecting, using image processing software, a plurality of features relevant to pricing property insurance for the uninsured property;
(d) pricing an insurance policy for the property based at least on the detected plurality of relevant features.

50. The method of claim 49, wherein a relevant feature is whether the property is a commercial property.

51. A system for identifying new customers for a property insurance product comprising:
(a) a computer server receiving a property inspection for a property of a non-policyholder, wherein the property inspection includes digital information about the physical condition of the property, and wherein the digital information is recorded using at least one electronic sensor;
(b) a computer processor electronically comparing the property inspection to at least a portion of the digital information of a similar property inspection, wherein the second property inspection is for a similar insured property, stored in a database of property inspections, and includes digital information about the condition of the property, and wherein the comparison is performed automatically by the computer processor;
(c) image processing software for detecting a plurality of features relevant to pricing property insurance for the uninsured property, wherein the plurality of relevant features are used to price an insurance policy for the property based at least on the detected plurality of relevant features.

52. The system of claim 51, wherein a relevant feature is whether the property is a commercial property.
